(19) United States
(12) Patent Application Publication
(10) Pub. No.: US 2025/0022399 A1
(43) Pub. Date: Jan. 16, 2025

(54) Method of controlling display panel and display driver circuit and scan control circuit thereof

(71) Applicant: NOVATEK Microelectronics Corp., Hsin-Chu (TW)

(72) Inventor: Huan-Teng Cheng, Hsinchu City (TW)

(73) Assignee: NOVATEK Microelectronics Corp., Hsin-Chu (TW)

(21) Appl. No.: 18/675,178

(22) Filed: May 28, 2024

Related U.S. Application Data
(60) Provisional application No. 63/526,192, filed on Jul. 12, 2023.

(51) Int. Cl. G09G 3/20

(52) U.S. Cl. CPC G09G 3/2092; G09G 2300/0814; G09G 2310/0267; G09G 2330/021; G09G 2340/0435

(57) ABSTRACT

A method of controlling a display panel, wherein the display panel has a plurality of pixels among which a line of pixels are divided into a plurality of groups of pixels, includes steps of: generating a scan control signal for the line of pixels when scanning the line of pixels; outputting a plurality of enable signals, each for controlling one of the plurality of groups of pixels; and determining whether to output a scan signal to each of the plurality of groups of pixels according to the scan control signal and each of the plurality of enable signals when scanning the line of pixels.

### CROSS REFERENCE TO RELATED APPLICATIONS

This application claims the benefit of U.S. Provisional Application No. 63/526, 192, filed on Jul. 12, 2023. The content of the application is incorporated herein by reference.

### BACKGROUND OF THE INVENTION

### 1. Field of the Invention

The present invention relates to a method of controlling a display panel, and more particularly, to a method of controlling a display panel under multi-frequency display and related display driver circuit and scan control circuit.

### 2. Description of the Prior Art

Multi-frequency display (MFD) is a novel display technique which generates images with different frame rates in different areas of the display panel. Under the MFD, an image frame may be dynamically divided into one or more high frame rate (HFR) areas and one or more low frame rate (LFR) areas. For example, an area for displaying a video is preferably allocated to the HFR area, and other areas showing text content are preferably allocated to the LFR area. The MFD operations may save power consumption by reducing the refresh number of times in the LFR areas, while keeping the refresh rate to achieve satisfactory image quality in the HFR areas, where the refresh rate allocations in each image frame may be performed dynamically to be adapted to the image content.

In general, a display panel may include a plurality of pixels arranged as an array. Multiple data lines (or called source lines) and multiple scan lines (or called gate lines) are deployed on the display panel for controlling the pixels, where each data line may be deployed along y-direction and vertically coupled to a column of pixels, and each scan line may be deployed along x-direction and horizontally coupled to a row of pixels. In other words, the direction that the scan lines connect the pixels is the x-direction, and the direction that the data lines connect the pixels is the y-direction. In this panel architecture, the pixels on the display panel may be scanned row by row from up to down; that is, the scan operation is performed along the y-direction.

Based on the above display features, the conventional MED operations partition the active areas of the display panel in the y-direction. However, the x-direction partition for different frame rate allocations is not feasible in the conventional MFD operations.

### SUMMARY OF THE INVENTION

It is therefore an objective of the present invention to provide a method of controlling a display panel under multi-frequency display (MFD) and related display driver circuit and scan control circuit, which support the x-direction n partition for MFD applications, in order to solve the abovementioned problem.

An embodiment of the present invention discloses a method of controlling a display panel. The display panel has a plurality of pixels, among which a line of pixels are divided into a plurality of groups of pixels. The method comprises steps of: generating a scan control signal for the line of pixels when scanning the line of pixels; outputting a plurality of enable signals, each for controlling one of the plurality of groups of pixels; and determining whether to output a scan signal to each of the plurality of groups of pixels according to the scan control signal and each of the plurality of enable signals when scanning the line of pixels.

Another embodiment of the present invention discloses a display driver circuit for controlling a display panel. The display panel has a plurality of pixels, among which a line of pixels are divided into a plurality of groups of pixels. The display driver circuit controls a scan control circuit to generate a scan control signal for the line of pixels when the line of pixels are scanned; outputs a plurality of enable signals, wherein each of the plurality of enable signals controls one of the plurality of groups of pixels; and determines whether to output a scan signal to each of the plurality of groups of pixels according to the scan control signal and each of the plurality of enable signals when the line of pixels are scanned.

Another embodiment of the present invention discloses a scan control circuit of a display panel, wherein the display panel has a plurality of pixels. The scan control circuit comprises at least one shift circuit and a multiplexer circuit. Each of the at least one shift circuit generates a plurality of scan control signals, wherein each of the plurality of scan control signals is for a line of pixels among the plurality of pixels. The multiplexer circuit, coupled to the at least one shift circuit, receives the plurality of scan control signals and a plurality of enable signals, to generate and output a plurality of scan signals to the plurality of pixels. A line of pixels among the plurality of pixels are divided into a plurality of groups of pixels, and each of the plurality of scan signals for the line of pixels corresponds to one group of the plurality of groups of pixels.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates the scan operations in 4 consecutive image frames to realize different frame rates in each area.

FIG. 2 is a schematic diagram of partial update of image data in a display system.

FIG. 3 illustrates that the DDIC refreshes the display panel to realize different frame rates in different areas.

FIG. 4 illustrates that the general y-direction partition might not effectively achieve power saving when a mobile phone is operated in the landscape mode.

FIG. 5 illustrates an application scenario where a video is shown in the landscape mode of the mobile phone.

FIG. 6 illustrates another application of the x-direction partition.

FIG. 7A and FIG. 7B are schematic diagrams of implementations of the x-direction partition on a display panel.

FIG. 8 illustrates a target refresh rate arrangement realized with the x-direction partition.

FIG. 9 is a flowchart of a scan process according to an embodiment of the present invention.

FIG. 10 illustrates a detailed implementation of a part of the display panel shown in FIG. 7A or a part of the display panel shown in FIG. 7B.

FIG. 11 is a waveform diagram of the scan control circuit shown in FIG. 10.

FIG. 12 is a schematic diagram of a detailed implementation of pixels in the active area of the display panel.

FIG. 13 is a schematic diagram of another display panel according to an embodiment of the present invention.

FIG. 14 illustrates a detailed implementation of the scan lines coupled to the pixels shown in FIG. 13.

FIG. 15 illustrates an exemplary implementation of a logic operation circuit according to an embodiment of the present invention.

FIG. 16 illustrates another frame rate allocation on the display panel.

FIG. 17 illustrates the operations of the scan control circuit to realize this frame rate allocation.

FIG. 18 is a waveform diagram of the scan control circuit shown in FIG. 17.

FIG. 19 illustrates a further frame rate allocation on the display panel.

FIG. 20 illustrates the operations of the scan control circuit to realize this frame rate allocation.

FIG. 21 is a waveform diagram of the scan control circuit shown in FIG. 20.

FIG. 22 illustrates several possible HFR and LFR allocations on a display panel.

FIG. 23 illustrates the power saving effect achieved on the data lines when the x-direction partition is applied.

FIG. 24 illustrates the power saving effect achieved with scan control.

FIG. 25 illustrates an application scenario of the x-direction partition on a display panel of a display system.

FIG. 26A and FIG. 26B are schematic diagrams of partial update of image data in a display system with the compression blocks corresponding to the group size.

FIG. 27 illustrates an exemplary frame rate allocation in a series of image frames according to an embodiment of the present invention.

### DETAILED DESCRIPTION

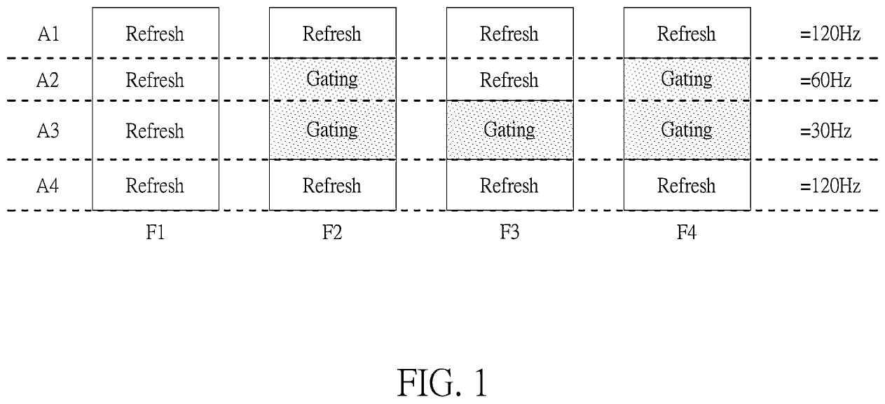

FIG. 1 illustrates the scan operations in 4 consecutive image frames F1-F4 to realize different frame rates in each area A1-A4. In the display panel, the image frame Fl is fully refreshed and the image frames F2-F4 are partially refreshed based on the frame rate allocation. More specifically, in the image frames F2 and F4, the areas A2 and A3 are allocated as low frame rate (LFR) areas, where the scan signals are gated and thus the corresponding pixels are not refreshed, while the panel refresh is performed in the areas Al and A4 which are allocated as high frame rate (HFR) areas. In the image frame F3, the area A3 is allocated as an LFR area, where the scan signals are gated and thus the corresponding pixels are not refreshed, while the panel refresh is performed in the areas A1, A2 and A4 which are allocated as HFR areas. Supposing that the basic frame rate of the panel is 120 Hz, the refreshing operations may be repeatedly performed in a series of consecutive image frames as the arrangements shown in FIG. 1, to achieve lower frame rates such as 60 Hz and 30Hz. The display driver circuit may be triggered to perform the multi-frequency display (MFD) in any appropriate manner. In an embodiment, the display driver circuit may only receive partial display data in an image frame from the video source, and determine the positions allocated to the HFR areas and/or the LFR areas based on the image content. Alternatively, the display driver circuit may receive a notification from the video source that indicates which areas need to be refreshed and which areas need not to be refreshed, to determine the positions allocated to the HFR areas and/or the LFR areas.

As shown in FIG. 1, the display panel is partitioned into 4 areas A1-A4 having respective frame rates. In those areas of several image frames where the refresh is not needed, the corresponding scan lines are gated to a specific level to disable the refresh operation of the connected pixels. Therefore, a row of pixels (which may be connected to the same scan line) should be refreshed or not refreshed simultaneously, and a frame rate is allocated to each row of pixels, thereby realizing the y-directional partition.

Note that the above operation can only support the y-direction partition, and thus may be limited to the applications in a general mobile phone where a video may be shown in the middle rows with a system bar on the top and a text area (e.g., a chat room) below the video area, and the refresh area should fully occupy one or more entire rows of pixels displaying the video in most image frames. However, the conventional approach may not support the x-direction partition in the MFD applications.

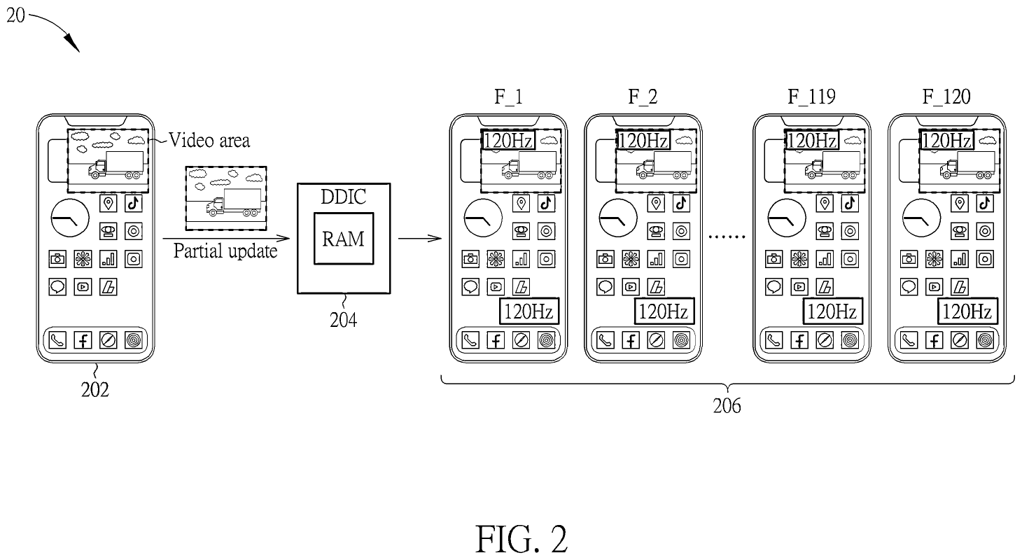

FIG. 2 is a schematic diagram of partial update of image data in a display system 20. The display system 20 includes an application processor (AP) 202, a display driver circuit 204 and a display panel 206. The AP 202, which may be a core processor of the display system 20, may serve as a video source or video provider for providing display data to be displayed by the display panel 206. The display driver circuit 204 may process the display data and convert the display data into data voltages to be output to the pixels on the display panel 206. In an embodiment, the display driver circuit 204 may be implemented in an integrated circuit (IC) to realize a display driver IC (DDIC). In the following descriptions, the display driver circuit will be abbreviated as DDIC, and those skilled in the art would know that the DDIC described hereinafter may represent a display driver circuit capable of driving a display panel and implemented in any manner. The display panel 206 may be any type of display device, which may be, but not limited to, an organic light emitting diode (OLED) panel, liquid crystal display (LCD) panel, or any other panel performing display by receiving scan signal control.

Partial update of image data is performed in the display system 20. The partial update means that the AP 202 only sends partial image data of an image frame, which are usually the video data, to the DDIC 204. The DDIC 204 may write the newly received image data into its memory (e.g., random access memory (RAM)) to replace the previous image data in the same area, while other image data not updated still remain in the RAM.

Subsequently, the DDIC 204 refreshes the display panel 206 by outputting all image data in a frame to the display panel 206. No power saving can be achieved on the display panel 206 since all the pixels on the display panel 206 are refreshed. FIG. 2 shows the refresh operations in a series of image frames (i.e., from F_1 to F_120). It can be seen that all image data are output to the display panel 206 in these image frames.

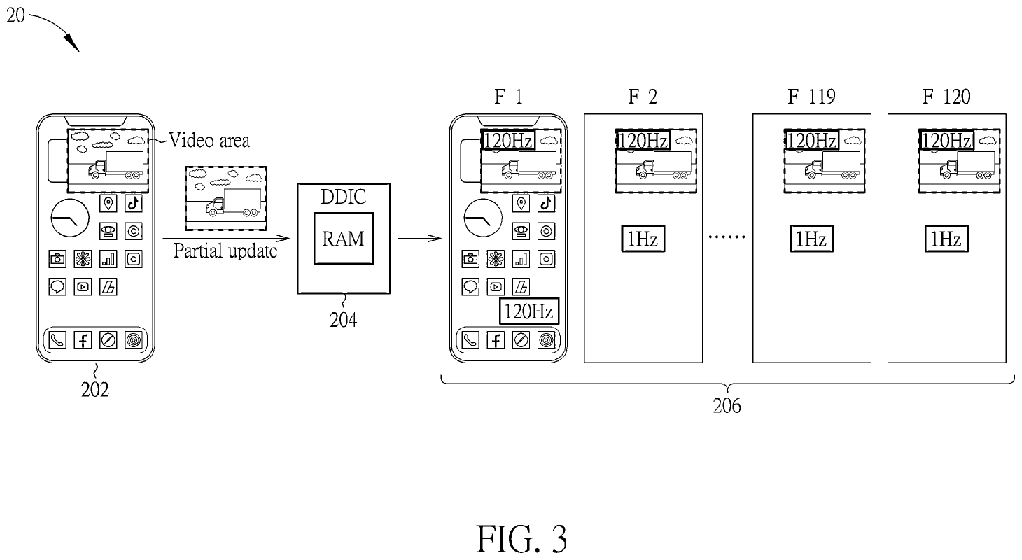

In an embodiment, based on the approach of partitioning the display panel 206 in both x-direction and y-direction, the display panel 206 may be refreshed only in specific area(s) with the partial update implementation. For example, as shown in FIG. 3, the AP 202 only sends partial image data in the video area to the DDIC 204 in the similar manner. The DDIC 204 does not output the image data of entire frames to the display panel 206; instead, the DDIC 204 may only refresh the pixels in the video area in these image frames, so as to realize different frame rates in different areas. In this embodiment as shown in FIG. 3, the video area is refreshed in a high frame rate 120 Hz, while other areas showing a static image are refreshed with an extremely low frame rate 1 Hz; that is, the LFR areas may be refreshed in one of every 120 image frames. This achieves a significant reduction of power consumption.

Therefore, power saving may be achieved in both the DDIC 204 and the display panel 206 under the partial update implementation. In the display panel 206, it is feasible to refresh partial areas in one or more image frames with the MFD operation. Therefore, in the non-refresh areas, the pixels do not receive any image data, and thus the corresponding data lines will not be charged or discharged by the data voltages. Correspondingly, the scan line output for the non-refresh areas is gated or disabled; that is, the gate driver or gate-on-array (GOA) circuit does not need to output the scan signals to drive the loads on the display panel 206, thereby saving the power consumption of gate/scan control.

In the DDIC 204, since the image data quantities received from the AP 202 and output to the display panel 206 are reduced, there are less image data needing to be processed by the DDIC 204. For example, the digital circuit of the DDIC 204 may include several signal processing circuits used for performing several signal processing operations on the received image data, such signal processing operations may include, but not limited to, Mura compensation, subpixel rendering, and brightness and contrast adjustments. The signal processing circuits only need to process the image data in a small video area that need to be refreshed, which may only use a little processing time. Therefore, the signal processing circuits may be disabled or the clock signals for these signal processing circuits may be stopped at the time when no image data need to be processed, thereby achieving power saving in the DDIC 204.

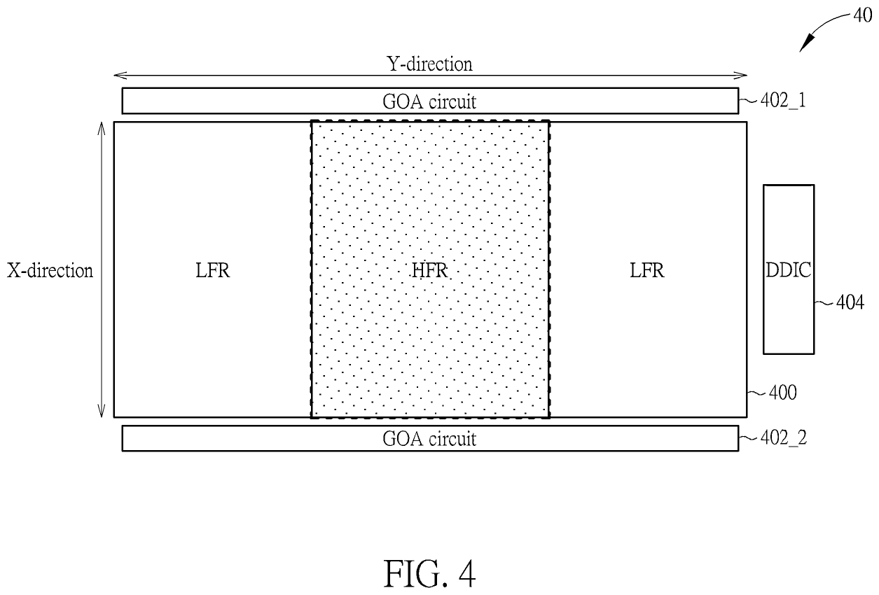

FIG. 4 illustrates that the general y-direction partition might not effectively achieve power saving when a mobile phone 40 is operated in the landscape mode. As shown in FIG. 4, the mobile phone 40 includes a display panel 400, which performs display as being controlled by GOA circuits 402_1 and 402_2 and a DDIC 404. When the display panel 400 is put horizontally, the DDIC 404 may be deployed at the right side of the display panel 400, and the GOA circuits may be at the top and/or bottom of the display panel 400. FIG. 4 shows that there are 2 GOA circuits 402_1 and 402_2 deployed at both sides of the display panel 400, but in another embodiment, there may be only one GOA circuit deployed at the top or bottom of the display panel.

In such a situation, the x-direction is vertical and the y-direction is horizontal. As mentioned above, the conventional MFD operation allocates the HFR and LFR areas in the y-direction since a row of pixels coupled to the same scan line should be refreshed or not simultaneously. However, in the prior art, different frame rates cannot be allocated to different areas partitioned in x-direction.

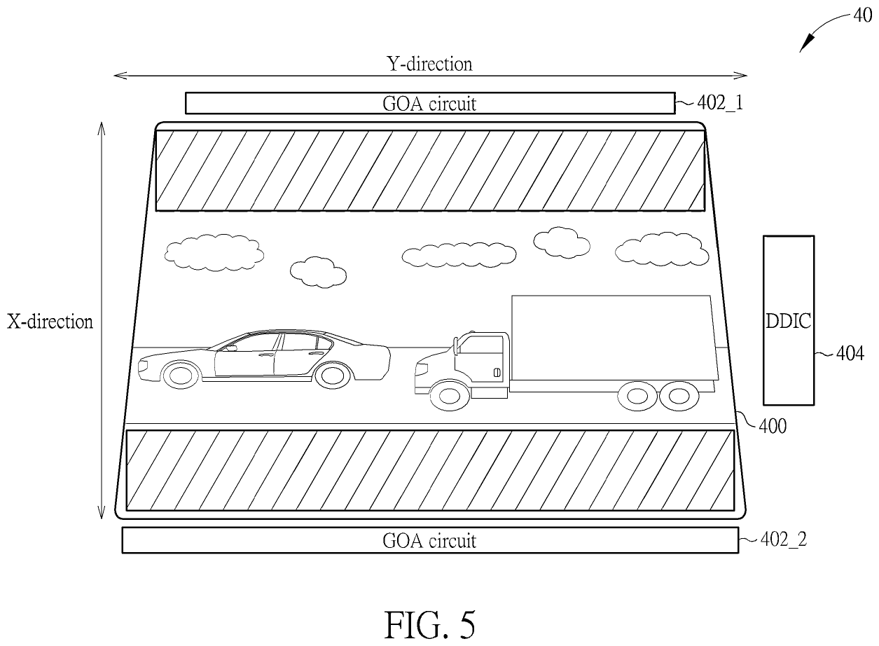

For example, under several application scenarios where a video is shown in the landscape mode of the mobile phone 40, as shown in FIG. 5, where the blanking (or text) areas are at the top and the bottom of the display panel 400 and the video is shown in the middle, the y-direction partition of HER and LFR areas as shown in FIG. 4 cannot realize the blanking areas of FIG. 5 without refreshing. In contrast, if the x-direction partition is applied, the refresh in upper and lower blanking areas may be omitted, thereby achieving power saving effects with MFD operations in the landscape mode.

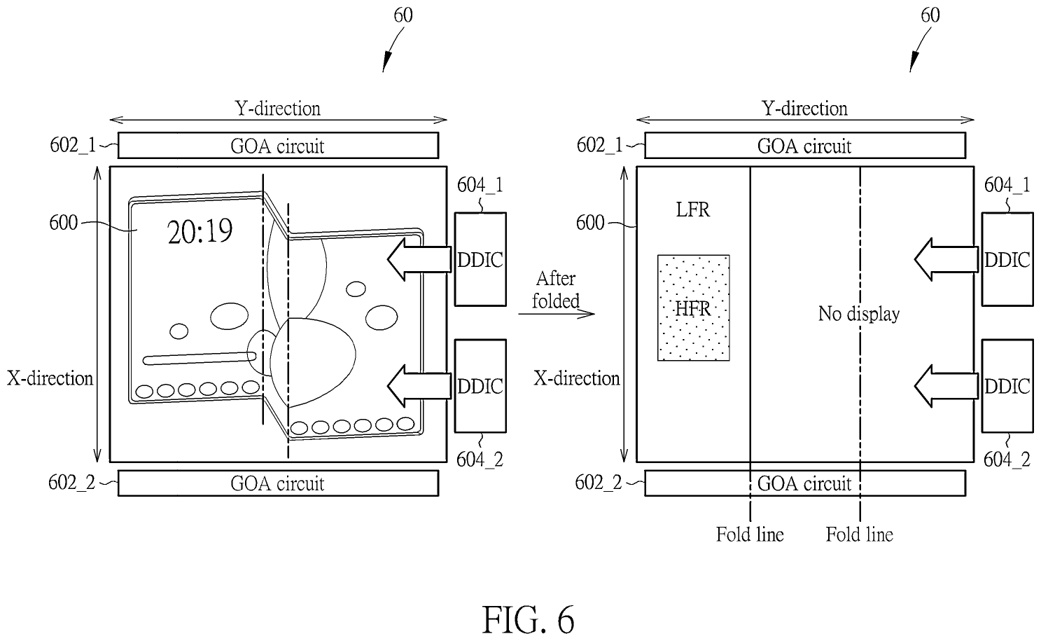

FIG. 6 illustrates another application of the x-direction partition, where different frame rates may be allocated to different display areas of a fold phone 60. The fold phone 60 may also include a display panel 600, which performs display as being controlled by GOA circuits 602_1 and 602_2 and DDICs 604_1 and 604_2. As shown in FIG. 6, the 2 cascaded DDICs 604_1 and 604_2 are deployed at the right side of the display panel 600, and the GOA circuits 602_1 and 602_2 may be at the top and/or bottom of the display panel 600. Note that the implementation shown in FIG. 6 is only an exemplary example. In another fold phone, there may be only one DDIC or more than 3 DDICs commonly controlling the display panel, or only one GOA circuit at the top or bottom of the display panel may be included, but not limited thereto.

The display panel 600 of the fold phone 60 includes 3 parts based on the separation of fold lines. The display of the fold phone 60 may be operated as a mobile phone when it is folded, and operated as a tablet when it is unfolded. After the fold phone 60 is folded as shown in the right-half part of FIG. 6, only the left part of the display panel 600 shows images, while the middle and right parts without display are preferably not refreshed, in order to save power consumption. The y-direction partition can only disable the refresh in the middle and right parts/areas of the display panel 600 which are folded, but may not perform MFD operations in the left display part/area of the display panel 600. The MFD operations in the left display part may be realized by using the x-direction partition, where the HFR area(s) and the LFR area(s) may be allocated in any appropriate manner. With the cooperation of the x-direction partition and y-direction partition, the frame rates in the left display part of the display panel 600 may be allocated flexibly, which achieves a significant improvement of power saving in the application of the fold phone 60.

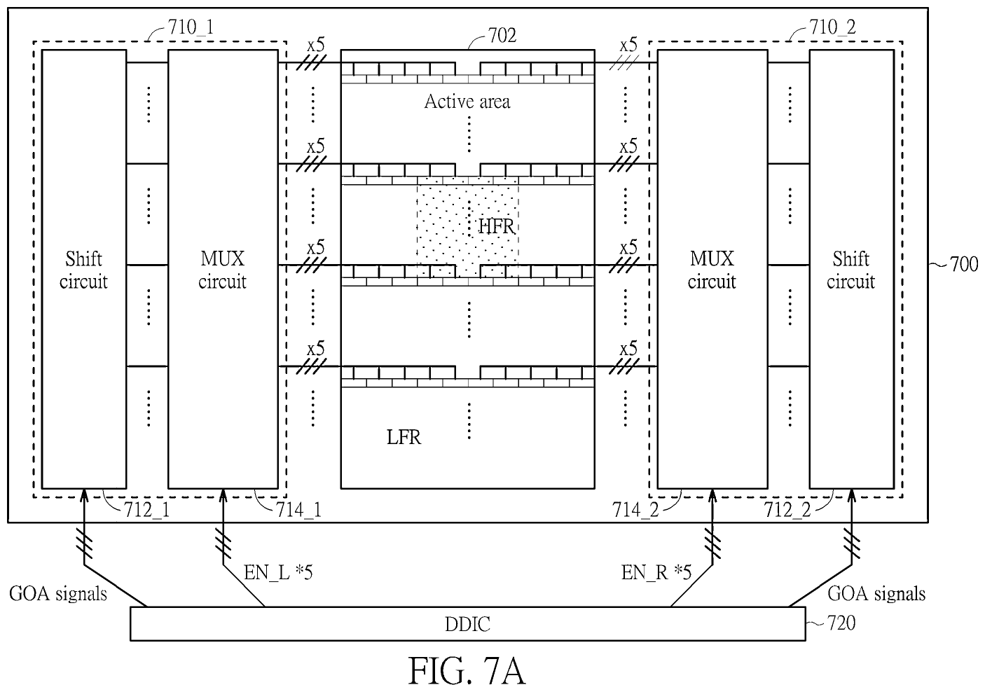

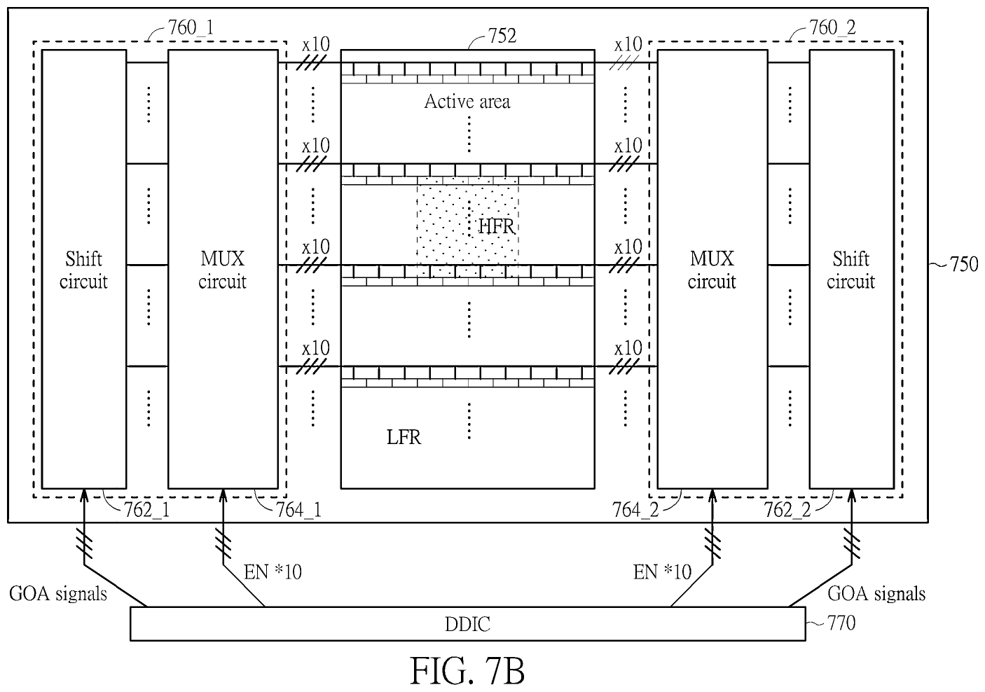

FIGS. 7A and 7B are schematic diagrams of implementations of the x-direction partition on a display panel. FIG. 7A illustrates a display panel 700, which includes an active area 702 and two scan control circuits 710_1 and 710_2 respectively deployed at the left side and the right side of the active area 702. The display panel 700 is controlled by a DDIC 720, which may be deployed below the display panel 700. FIG. 7A illustrates that the left scan control circuit 710_1 drives the left-half part of the display panel 700 and the right scan control circuit 710_2 drives the right-half part of the display panel 700; that is, the scan lines corresponding to the scan control circuit 710_1 are not connected to the scan lines corresponding to the scan control circuit 710_2. In this embodiment, there may be 1080 pixels in a row, which are divided into 10 groups, and each group has 108 pixels. The left scan control circuit 710_1, which is responsible for controlling the left-half panel, may be coupled to 5 groups of pixels in each row; the right scan control circuit 710 2, which is responsible for controlling the right-half panel, may be coupled to another 5 groups of pixels in each row. The panel structure that the left scan control circuit 710_1 and the right scan control circuit 710_2 drive their corresponding areas separately may simplify the fanout of wire connections on the display panel 700, and thus may be preferable in consideration of circuit costs and complexity.

FIG. 7B illustrates another display panel 750, which includes an active area 752 and two scan control circuits 760_1 and 760_2 respectively deployed at the left side and the right side of the active area 752. The display panel 750 is controlled by a DDIC 770, which may be deployed below the display panel 750. As shown in FIG. 7B, the display panel 750 has another implementation where the left scan control circuit 760_1 and the right scan control circuit 760_2 commonly drive all the pixels in the active area 752; that is, each scan line on the display panel 750 is connected between the left and right scan control circuits 760_1 and 760_2. In this embodiment, if a row of pixels are divided into 10 groups, the scan control circuits 760_1 and 760_2 may be commonly coupled to a row of pixels through 10 scan lines, where each scan line is coupled to one of the 10 groups of pixels. The implementation shown in FIG. 7B may achieve better reliability since a scan signal may be simultaneously output from the left scan control circuit 760_1 and the right scan control circuit 760_2.

As shown in FIGS. 7A and 7B, each of the scan control circuits 710_1, 710_2, 760_1 and 760 2 may include a shift circuit (denoted by 712_1, 712_2, 762_1 and 762_2, respectively) and a multiplexer (MUX) circuit (denoted by 714_1, 714_2, 764_1 and 764_2, respectively). Each shift circuit 712_1, 712_2, 762_1 and 762_2 may be included in a GOA circuit of the display panel 700 or 750. Each MUX circuit 714_1, 714_2, 764_1 and 764_2 may be considered as coupled between the corresponding GOA circuit and the active area 702 or 752 of the display panel 700 or 750, or considered as included in the GOA circuit of the display panel 700 or 750. The shift circuits 712_1, 712_2, 762_1 and 762_2 may receive GOA signals (including GOA clocks, start pulses and/or reset signals, but not limited thereto) from the corresponding DDICs 720 and 770, and correspondingly generate a scan control signal for each row of pixels. The MUX circuits 714_1, 714_2, 764_1 and 764_2 may receive the scan control signals from the corresponding shift circuits 712_1, 712_2, 762_1 and 762_2, where each scan control signal is used for controlling a row of pixels. The MUX circuits 714_1, 714_2, 764_1 and 764_2 may also receive enable signals from the corresponding DDICs 720 and 770, and correspondingly output multiple scan signals to the pixels according to the enable signals and the scan control signals, where each scan signal corresponds to a group of pixels.

For example, in the embodiment of FIG. 7A, a row of pixels are divided into 10 groups, and the left-half part of the display panel 700 is controlled by the left scan control circuit 710_1 and the right-half part of the display panel 700 is controlled by the right scan control circuit 710_2. Therefore, each of the scan control circuits 710_1 and 710_2 may control 5 groups of pixels in one row, and thus may output 5 scan signals to the 5 groups of pixels, respectively. The MUX circuits 714_1 and 714_2 may receive 5 enable signals (EN_L, EN_R) to generate the 5 scan signals, respectively.

In the embodiment of FIG. 7B, a row of pixels are also divided into 10 groups, and the left scan control circuit 760_1 and the right scan control circuit 760_2 commonly control the 10 groups of pixels in each row. Therefore, each of the scan control circuits 760_1 and 760_2 may output 10 scan signals to the 10 groups of pixels, respectively. The MUX circuits 764_1 and 764_2 may receive 10 enable signals (EN) to generate the 10 scan signals, respectively.

The DDICs 720 and 770 may determine whether the scan signal is output to the corresponding group of pixels, and correspondingly output the enable signal to the scan control circuit. Each enable signal may control whether to enable or disable the scan signal output for the corresponding group of pixels. If a group of pixels are determined to be refreshed, the enable signal may be in a specific level to enable the scan signal to be output to this group; if a group of pixels are determined to be not refreshed, the enable signal may be in another level to gate the scan signal, so that the scan signal is locked at the level to turn off the corresponding transistors in the pixels. Therefore, in each image frame, each group of pixels may be set to be refreshed or not respectively and dynamically, so as to realize the x-direction partition. In addition, by sequentially scanning the pixels row by row, the y-direction partition may also be achieved.

Different from the conventional MFD operation where each scan signal is output to the entire row of pixels and refreshing or not is determined row by row, in the present invention, the x-direction partition may be realized by dividing a row of pixels into multiple groups and outputting a scan signal to each group, so that refreshing or not can be determined group by group.

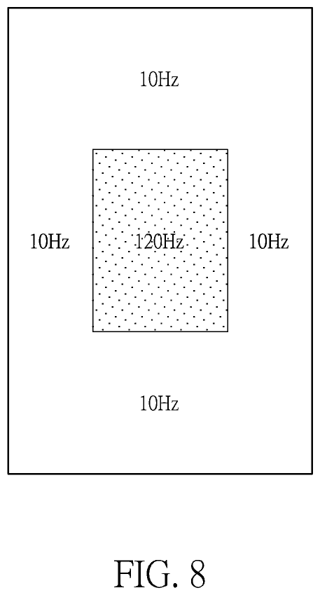

In such a situation, the grouping manner may achieve the combination of x-direction partition and y-direction partition. In an embodiment, the pixel structure shown in FIG. 7A or 7B may be arranged to have an HFR area in the middle surrounded by an LFR area. In order to realize this arrangement, 4 middle groups of pixels in several middle rows may be allocated to the HFR area, while other groups are allocated to the LFR area. A target refresh rate arrangement as shown in FIG. 8 may be realized, where the middle HFR area may be refreshed with a high frame rate 120 Hz, and the peripheral LFR area may be refreshed with a low frame rate 1 Hz.

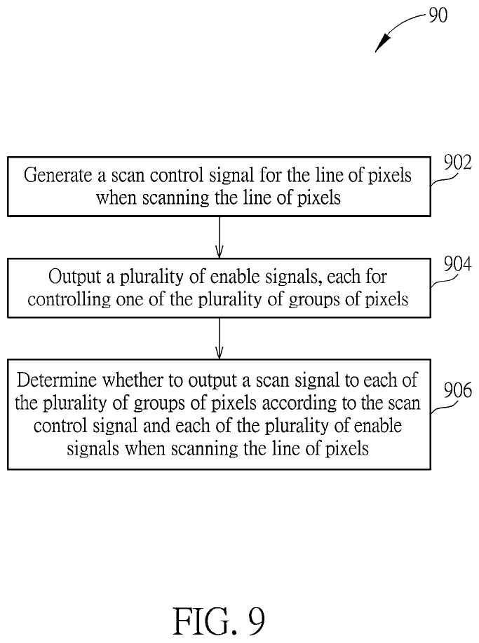

FIG. 9 is a flowchart of a scan process 90 according to an embodiment of the present invention. The scan process 90 may be implemented in a DDIC and a scan control circuit for controlling a display panel, such as the DDICs 720 and 770 and the scan control circuits 710_1, 710_2, 760_1 and 760_2 shown in FIGS. 7A and 7B. The display panel may have a plurality of pixels, where a line of pixels are divided into a plurality of groups of pixels. As shown in FIG. 9, the scan process 90 may include the following steps:

Step 902: Generate a scan control signal for the line of pixels when scanning the line of pixels.

Step 904: Output a plurality of enable signals, each for controlling one of the plurality of groups of pixels.

Step 906: Determine whether to output a scan signal to each of the plurality of groups of pixels according to the scan control signal and each of the plurality of enable signals when scanning the line of pixels.

In the display panel, the line of pixels may refer to a row of pixels or a column of pixels. As for a general mobile phone, the DDIC may be deployed below the display panel, and the scan control circuits (e.g., the GOA circuits) may be deployed at the left and/or right sides of the display panel. Therefore, a data line of the DDIC may be coupled to a column of pixels, and a scan line of the scan control circuit may be coupled to a row of pixels, so that each row of pixels may be divided into multiple groups to realize the x-direction partition. On the other hand, as for a tablet or a fold phone, the DDIC may be deployed at the left or right side of the display panel, and the scan control circuits may be deployed at the top and/or bottom of the display panel. Therefore, a data line of the DDIC may be coupled to a row of pixels, and a scan line of the scan control circuit may be coupled to a column of pixels, so that each column of pixels may be divided into multiple groups to realize the x-direction partition. Note that in these embodiments, the pixels may be scanned sequentially along the y-direction, and each line of pixels are deployed and grouped along the x-direction.

According to the scan process 90, the scan control circuit may generate a scan control signal for each line of pixels when scanning this line of pixels. The DDIC may output a plurality of enable signals, each corresponding to a group of pixels among this line of pixels, to the scan control circuit. Based on the enable signals, the scan control circuit may determine whether to output a scan signal to each group of pixels when scanning this line of pixels. More specifically, if a first group of pixels are determined to be refreshed in an image frame, the scan signal may be output to the first group of pixels in this image frame. If a second group of pixels are determined to be not refreshed in an image frame, the scan signal may not be output to the second group of pixels in this image frame, where the scan signal or scan line corresponding to the second group of pixels may be gated or stopped by using the corresponding enable signal. In other words, the scan signal may be output to the first group of pixels since the first group is allocated to the HFR area, and not output to the second group of pixels since the second group is allocated to the LFR area.

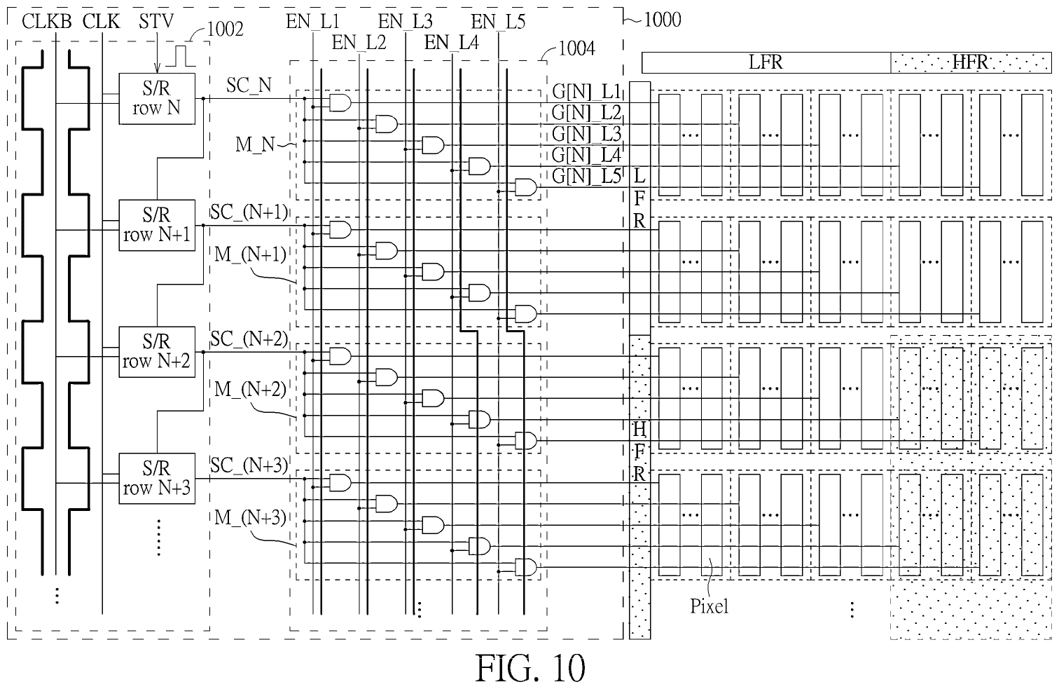

FIG. 10 illustrates a detailed implementation of a part of the display panel 700 shown in FIG. 7A or a part of the display panel 750 shown in FIG. 7B, where an exemplary structure of a shift circuit 1002 and a MUX circuit 1004 included in a scan control circuit 1000 is shown. The scan control circuit 1000 may output scan signals rightwards to the corresponding pixels; hence, it may be implemented to realize the left scan control circuit 710_1 or 760_1. The right scan control circuits 710_2 and 760_2 may be realized in a similar manner, and those skilled in the art may understand the structures and operations of the right scan control circuits 710_2 and 760_2 by referring to those shown in FIG. 10.

FIG. 10 shows several rows of pixels at the left-half panel and related circuitry in the scan control circuit 1000 used to control these pixels. In detail, each row of pixels includes 5 groups and each group of pixels may receive a scan signal from the MUX circuit 1004. The shift circuit 1002 may generate and output a scan control signal SC_N-SC_(N+3) for each row of pixels. For example, as for those pixels on row N, the MUX circuit 1004 may output 5 scan signals to the 5 groups of pixels through scan lines G[N]_L1-G[N]_L5, respectively. The shift circuit 1002 may output a scan control signal SC_N to the MUX circuit 1004 to be used for generating the scan signals for row N. In detail, the shift circuit 1002 may include a plurality of shift registers (S/R), each for outputting one of the scan control signals SC_N-SC_(N+3).

If a display panel only supports the y-direction partition, a scan control signal along with one enable signal may be used to generate a scan signal to be output to a row of pixels. In the embodiment in FIG. 10, the x-direction partition is incorporated, the structure of the shift circuit 1002 may still be the same, and the MUX circuit 1004 is implemented with multiple logic operation circuits M_N-M_(N+3), where each logic operation circuit M N-M (N+3) is coupled to a row of pixels, to be used for outputting scan signals to this row of pixels based on the control of enable signals EN_L1-EN_L5. The logic operation circuits M_N-M_(N+3) may receive the corresponding scan control signals SC_N-SC_(N+3) from the shift circuit 1002, respectively, and also receive the enable signals EN_L1-EN_L5 from the DDIC, in order to generate the scan signals. For example, as for those pixels on row N, the logic operation circuit M_N may include 5 output terminals, each coupled to a group of pixels located on row N. Each logic operation circuit M_N-M_(N+3) may include 5 logic gates, each performs a logic operation on the corresponding scan control signal SC_N-SC_(N+3) and one of the enable signals EN_L1-EN_L5, to generate the corresponding scan signal.

In this embodiment, it is supposed that the scan signals to be output to the display panel are used for controlling NMOS transistors and thus the scan signals are high-active signals, which are normally low and include high pulses in the corresponding horizontal line periods to turn on the NMOS transistors. Therefore, the logic operation circuits M_N-M_(N+3) apply “AND” gates to generate the scan signals. In such a situation, the scan signal is enabled when the corresponding enable signal is “High”, and is disabled (i.e., gated and forced to be “Low”) when the corresponding enable signal is “Low”.

As shown in FIG. 10, firstly, the enable signals EN_L1-EN_L5 are “Low” for the LFR area without refresh. When the scan operation enters the HFR area on row N+2, the corresponding enable signal may be switched “High”. In this embodiment, the enable signals EN_L4 and EN_L5 are switched “High” to enable the corresponding scan signals to refresh the pixel groups in the HFR area, while the enable signals EN_L1, EN_L2 and EN_L3 keep “Low”, thereby realizing the x-direction partition. Therefore, the x-direction partition may be performed by respectively controlling the status of each enable signal in each horizontal line period (spatial control), and the y-direction partition may be performed by controlling the status of an enable signal in different horizontal line periods throughout the frame period (timing control).

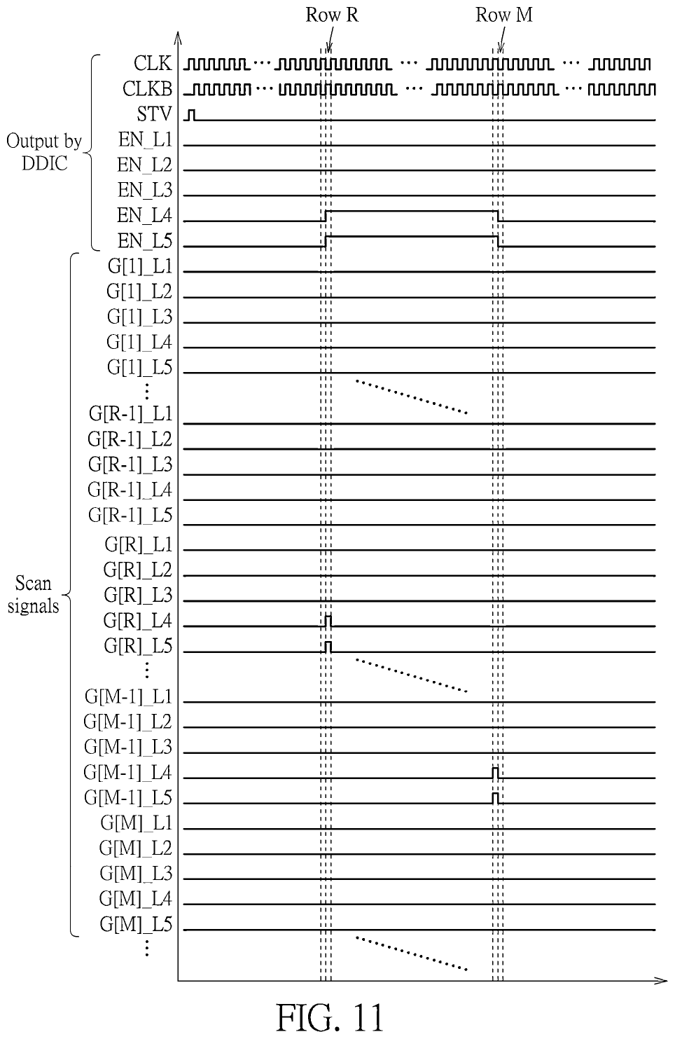

FIG. 11 is a waveform diagram of the scan control circuit 1000 shown in FIG. 10, which illustrates the scan operation proceeding from an LFR area to an HFR area and then to an LFR area. FIG. 11 shows the clock signals CLK and CLKB, the start pulse STV, the enable signals EN_L1-EN_L5, and the scan signals on the scan lines G[1]_L1-G[1]_L5, G[2]_L1-G[2]_L5 . . . G[M]_L1-G[M]_L5. . . . The clock signals CLK and CLKB and the start pulse STV may be output to the shift circuit 1002 by the DDIC. The enable signals EN_L1-EN_L5 may be output to the MUX circuit 1004 by the DDIC.

The HFR area starts from row R and ends at row M. Based on the x-direction partition, the HFR area only includes partial pixel groups in a row. Therefore, the corresponding enable signals EN_L4 and EN_L5 are pulled “High” to enable the scan control of these pixel groups, and other enable signals EN_L1-EN_L3 keep “Low” to make the corresponding scan lines gated “Low”. The scan signals in the scan lines G[x]_L4 and G[x]_L5 are sequentially output based on the shifting in the shift circuit 1002 in response to the start pulse STV, where x is from R to M−1 (R<(M−1)), as being corresponding to the HFR area and controlled by using the enable signals EN_L4 and EN_L5.

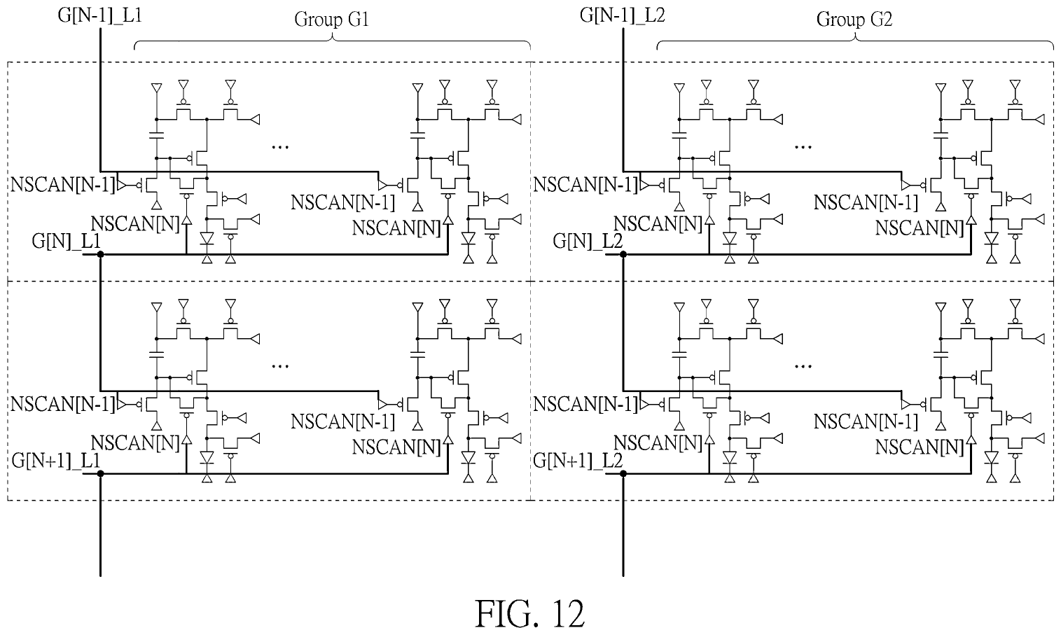

FIG. 12 is a schematic diagram of a detailed implementation of pixels in the active area of the display panel. In this embodiment, each pixel is coupled to two scan lines, to receive a current scan signal NSCAN[N] and a previous scan signal NSCAN[N-1]. In each row of pixels, two pixels belonging to different groups may be controlled by different sets of scan signals, wherein each set of scan signals include a current scan signal NSCAN[N] and a previous scan signal NSCAN[N-1]. For example, a pixel in a first group G1 may receive the current scan signal NSCAN[N] from the scan line G[N] L1 and receive the previous scan signal NSCAN[N-1] from the scan line G[N-1]_L1, and a pixel in a second group G2 may receive the current scan signal NSCAN[N] from the scan line G[N]_L2 and receive the previous scan signal NSCAN[N-1] from the scan line G[N-1]_L2. Each scan line may be coupled to a pixel group in a first row of pixels to forward the current scan signal NSCAN[N] to this pixel group, and also coupled to another pixel group in a second row of pixels to forward the previous scan signal NSCAN[N-1] to this pixel group.

In detail, in order to realize the x-direction partition, the structure of pixel circuits in the active area needs not to be changed or modified, and the grouping is realized by connecting different scan lines to different groups of pixels. These scan lines are respectively coupled to different output terminals of the MUX circuit included in the scan control circuit, which may be deployed at the border of the display panel. In another embodiment, as for each row of pixels, the scan lines for forwarding the current scan signal NSCAN[N] may be coupled to a scan control circuit, and the scan lines for forwarding the previous scan signal NSCAN[N-1] may be coupled to another scan control circuit. In a further embodiment, the pixels may have another circuit structure and thus may be requested to be coupled to different numbers of scan lines, to receive different numbers of scan signals from the scan control circuit(s).

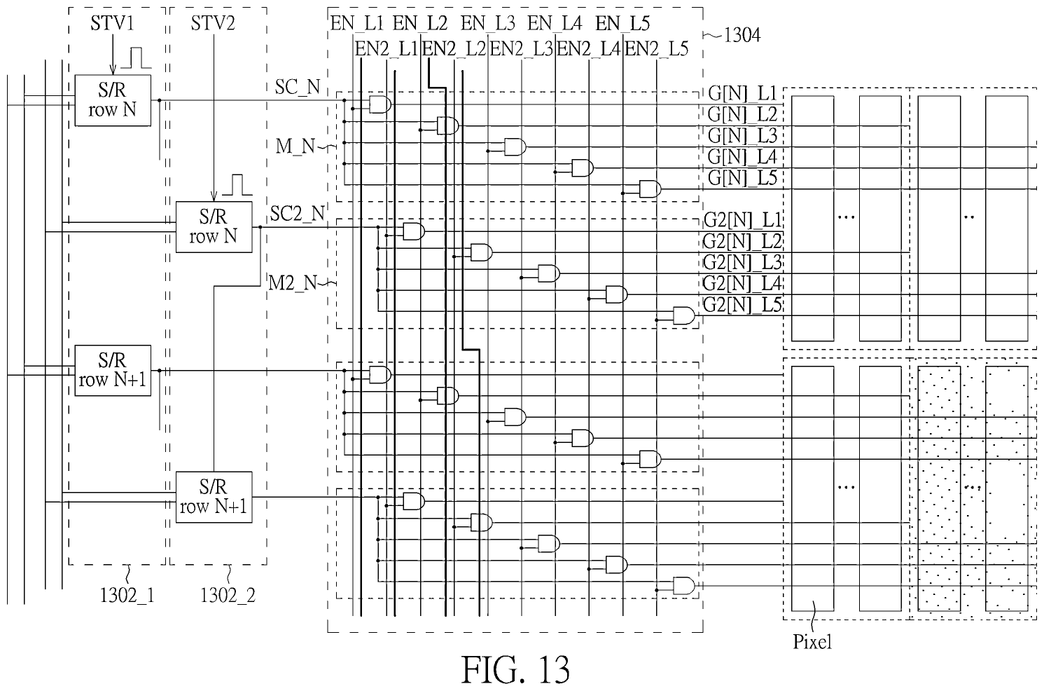

Since a group of pixels in a row may receive more than one scan signal from different scan lines, the scan signals may be generated by using different enable signals. FIG. 13 is a schematic diagram of another display panel according to an embodiment of the present invention. As shown in FIG. 13, there are two shift circuits 1302_1 and 1302_2 and a MUX circuit 1304 included in the scan control circuit. In this embodiment, although each row of pixels controlled by the scan control circuit have 5 groups, the scan control circuit may output 10 scan signals to the 5 groups of pixels, where each group of pixels receive 2 scan signals. The shift circuits 1302_1 and 1302, 2 may generate scan control signals by receiving different start pulses STV1 and STV2 and shifting the scan pulses, respectively, and output the scan control signals to the MUX circuit 1304. The MUX circuit 1304 may receive the scan control signals from the shift circuits 1302_1 and 1302_2, respectively, and also receive enable signals EN_L1-EN_L5 and EN2_L1-EN2_L5 from the DDIC. The MUX circuit 1304 may include 2 logic operation circuits for a row of pixels, to perform logic operations to generate the corresponding scan signals.

For example, as for the pixels on row N, the shift circuits 1302_1 and 1302, 2 may generate the scan control signals SC_N and SC2_N, respectively. The MUX circuit 1304 may receive the scan control signals SC_N and SC2_N from the shift circuits 1302_1 and 1302_2, respectively. In the MUX circuit 1304, the logic operation circuit M_N performs logic operations on the scan control signal SC N and each of the enable signals EN_L1-EN_L5, to generate 5 scan signals to be output through the scan lines G[N]_L1-G[N]_L5; and the logic operation circuit M2_N performs logic operations on the scan control signal SC2_N and each of the enable signals EN2_L1-EN2_L5, to generate another 5 scan signals to be output through the scan lines G2[N]_L1-G2[N]_L5. Correspondingly, each group of pixels is coupled to 2 scan lines, on which the scan signals may be generated from different scan control signals (e.g., SC_N and SC2_N). In other words, the scan signals received by a pixel may be generated by using different logic operation circuits according to different enable signals.

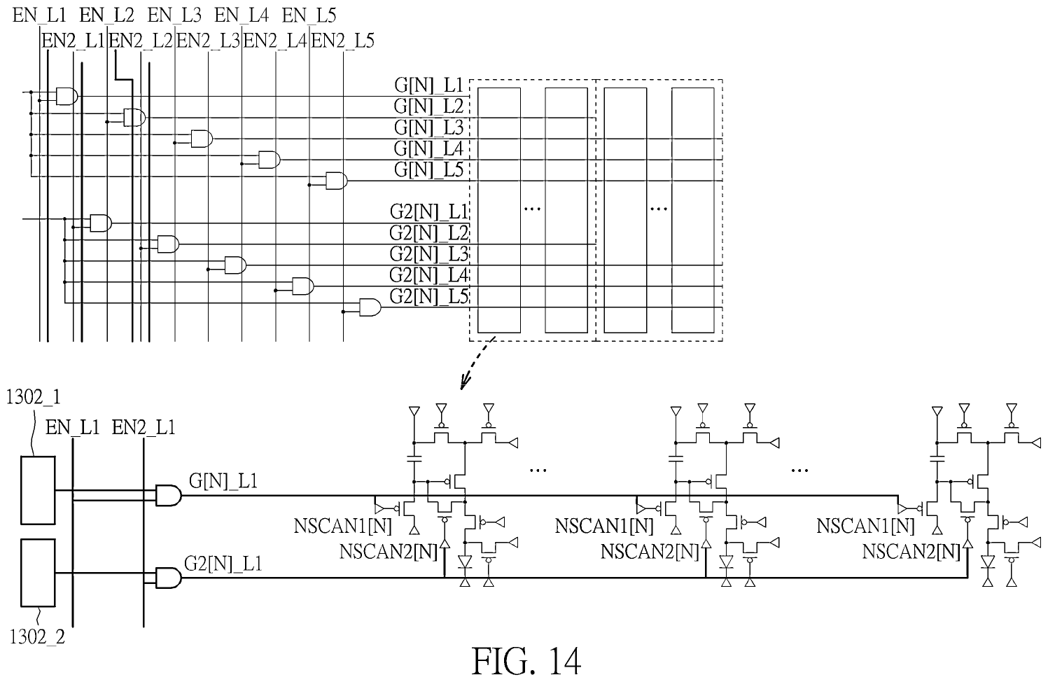

FIG. 14 illustrates a detailed implementation of the scan lines coupled to the pixels shown in FIG. 13. A pixel on row N may receive 2 scan signals NSCAN1[N] and NSCAN2[N] from 2 different scan lines (e.g., G[N]_L1 and G2[N]_L1), and these 2 scan signals NSCAN1[N] and NSCAN2[N] may be generated from different shift circuits 1302_1 and 1302_2 with a shift in their control timing, so as to solve the problem of horizontal line at the time instant where the frame rate changes. In an embodiment, the scan signal NSCAN1[N] may be a previous scan signal NSCAN[N-1] for controlling initial of each pixel, and the scan signal NSCAN2[N] may be a current scan signal NSCAN[N] for controlling data writing of each pixel. As shown in FIGS. 13 and 14, different shift circuits 1302_1 and 1302_2 along with different start pulses STV1 and STV2 may be used to generate the scan signals NSCAN1[N] and NSCAN2[N] having 1H shift, i.e., a shift of one horizontal line period, so as to realize the previous scan signal NSCAN[N-1] and the current scan signal NSCAN[N], respectively.

Note that FIGS. 13 and 14 show that each group of pixels is controlled by 2 shift circuits included in a scan control circuit, but the present invention is not limited thereto. In fact, a pixel group may be coupled to and controlled by (i.e., receive scan signals from) one or more scan control circuits (e.g., one or more GOA circuits), and the number of scan control circuits used for scan control should not be used to limit the scope of the present invention. In one aspect, each pixel group may receive a set of scan signals from the scan control circuit(s), where different pixel groups in the same row may receive different sets of scan signals. In an embodiment, a row of pixels are divided into 10 groups, and thus the scan control circuit may output 10 sets of scan signals to the 10groups of pixels, respectively. Each set of scan signals may include any number of scan signal(s), not limited to those described in this disclosure.

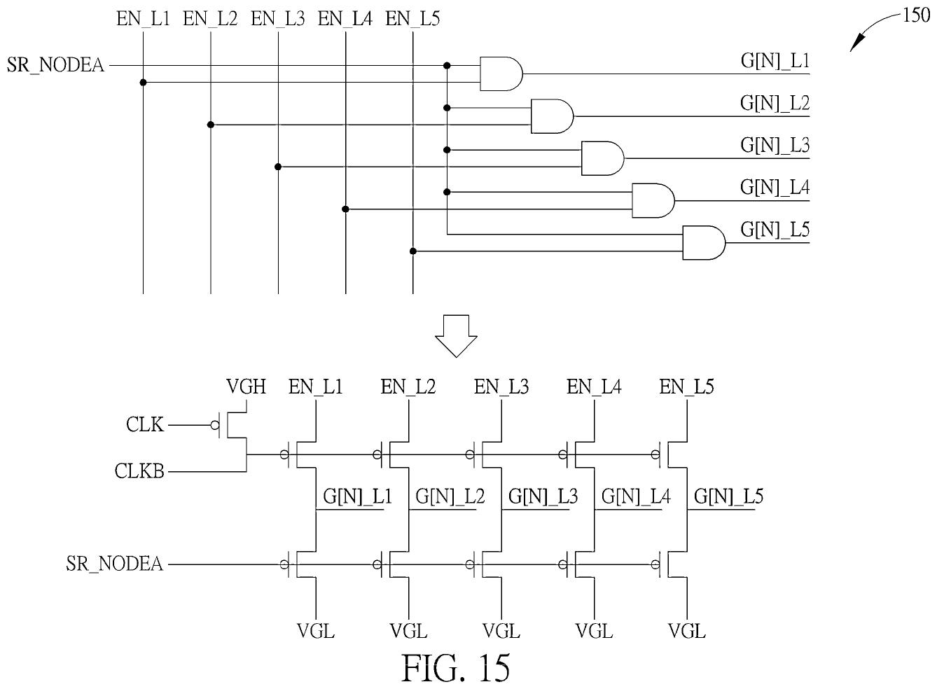

FIG. 15 illustrates an exemplary implementation of a logic operation circuit 150 according to an embodiment of the present invention. The logic operation circuit 150, which may be used to realize any of the logic operation circuits M_N-M(N+3), includes 5 “AND” gates coupled to 5 scan lines G[N]_L1-G[N]_L5, respectively. Each of the “AND” gates may be realized by using two transistors. The node SR NODEA refers to a corresponding output of the shift circuit. Each “AND” gate has two input terminals, of which one is coupled to the node SR_NODEA, and the other is coupled to the DDIC for receiving an enable signal (e.g., one of the enable signals EN_L1-EN_L5). The “AND” gate may generate a scan signal and output the scan signal to the corresponding pixel group through the corresponding scan lines G[N]_L1-G[N]_L5. In this embodiment, each “AND” gate may be commonly coupled to the input node SR NODEA and commonly receive the clock signals CLK/CLKB and the supply voltages VGH and VGL through the same terminals, in order to simplify the circuit structure. Based on this circuit structure shown in FIG. 15, a high pulse is generated at the scan line G[N]_L1-G[N]_L5 only when the clock signal CLK is “High”, the node SR_NODEA is “High”, and the corresponding enable signal is “High” (which means that the scan line is not gated).

In the above embodiment, the HFR area is at the center of the panel and surrounded by the LFR area, and this implementation may be realized by combining the x-direction partition and y-direction partition, where the x-direction partition is performed by respectively controlling the refresh of different pixel groups in a row, and the y-direction partition is performed by controlling the enable signals throughout the scan operations. Note that the HFR area (e.g., refresh area) and the LFR area (e.g., non-refresh area) may be allocated in any appropriate manner.

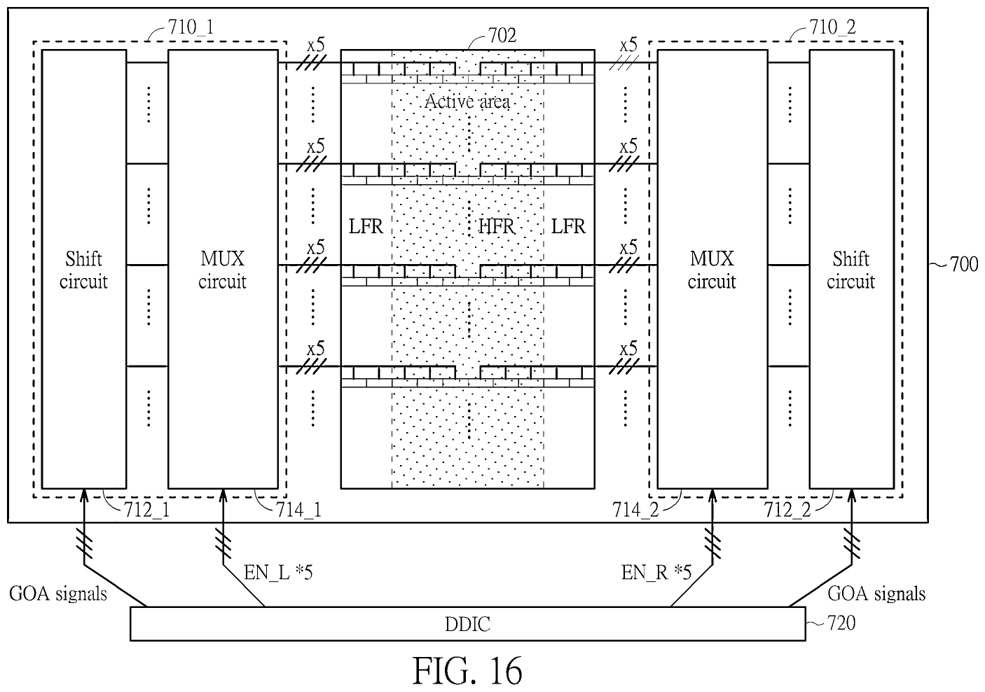

For example, FIG. 16 illustrates another frame rate allocation on the display panel 700, where the arrangements of pixel groups and related control circuits are identical to those shown in FIG. 7A, and thus the same circuit elements and signals are denoted by the same symbols. As shown in FIG. 16, the HFR area includes all pixels located in several middle columns, with two LFR areas at the left and right sides, respectively.

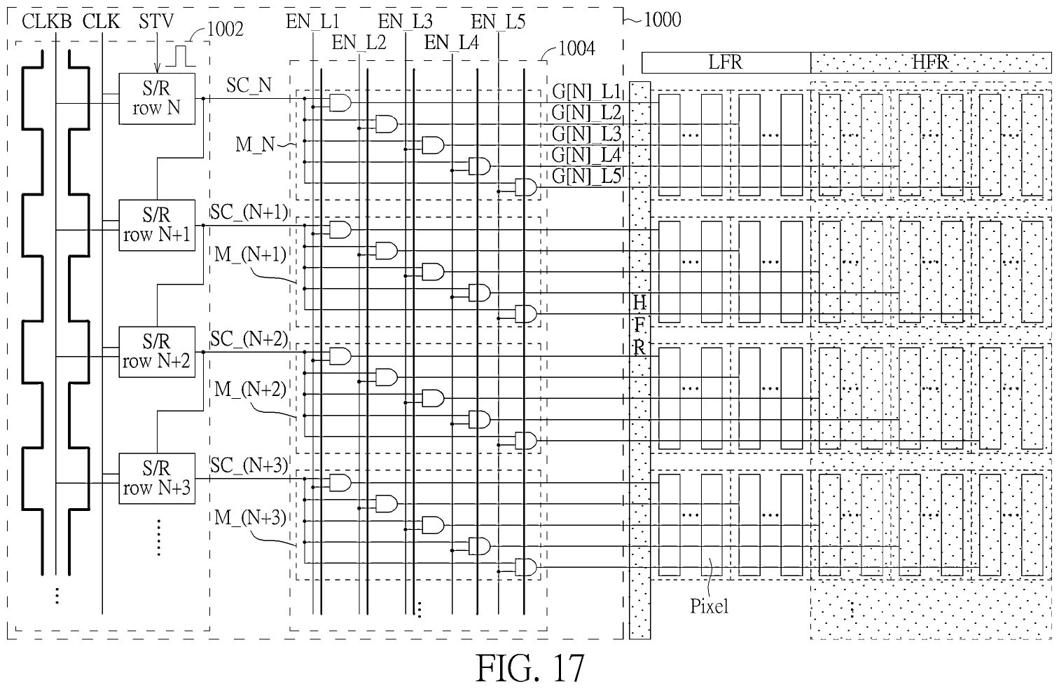

In this embodiment, the frame rate allocation may be realized by using the x-direction partition only, and FIG. 17 illustrates the operations of the scan control circuit to realize this frame rate allocation. As shown in FIG. 17, each of the enable signals EN_L1-EN_L5 is always “High” or always “Low” in this image frame, based on whether the corresponding pixel group is in the HFR area or the LFR area. More specifically, if a column of pixels are in the HER area, the corresponding enable signal(s) will always be “High”, or if a column of pixels are in the LFR area, the corresponding enable signal(s) will always be “Low”.

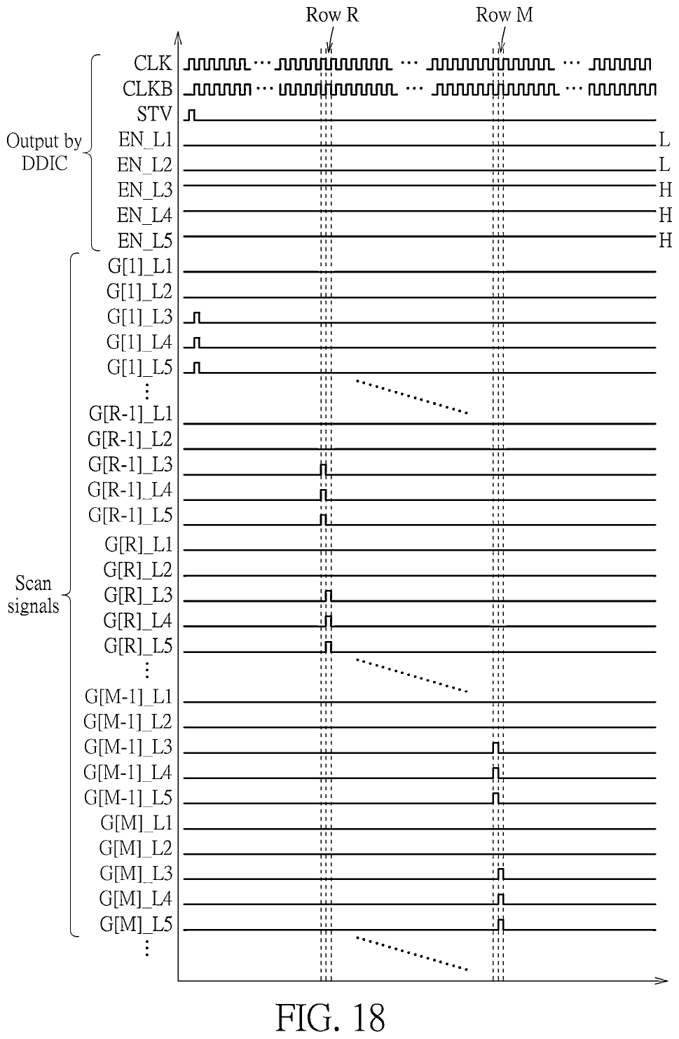

The detailed waveforms of the scan control circuit in this embodiment are illustrated in FIG. 18, where the scan signals on the display panel 700 and the signals output by the DDIC 720 are shown. As shown in FIG. 18, the enable signals EN_L1 and EN_L2 are always “Low” and the enable signals EN_L3, EN_L4 and EN_L5 are always “High” in this frame period. The scan signals are sequentially output through the scan lines G[x]_L3, G[x]_L4 and G[x]_L5, where x is from 1 to the total row count of the panel, which means that the total column of pixels allocated to the HFR area receive the scan signals.

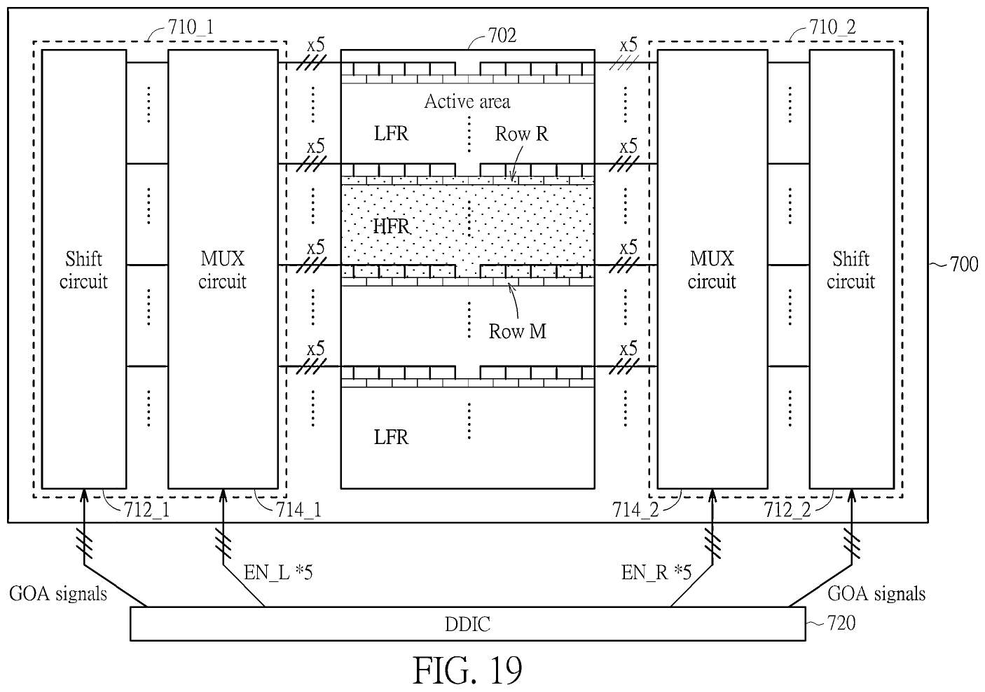

In another embodiment, the HFR area includes all pixels located in several middle rows, with two LFR areas above and below the middle HFR area, respectively, as shown in FIG. 19.

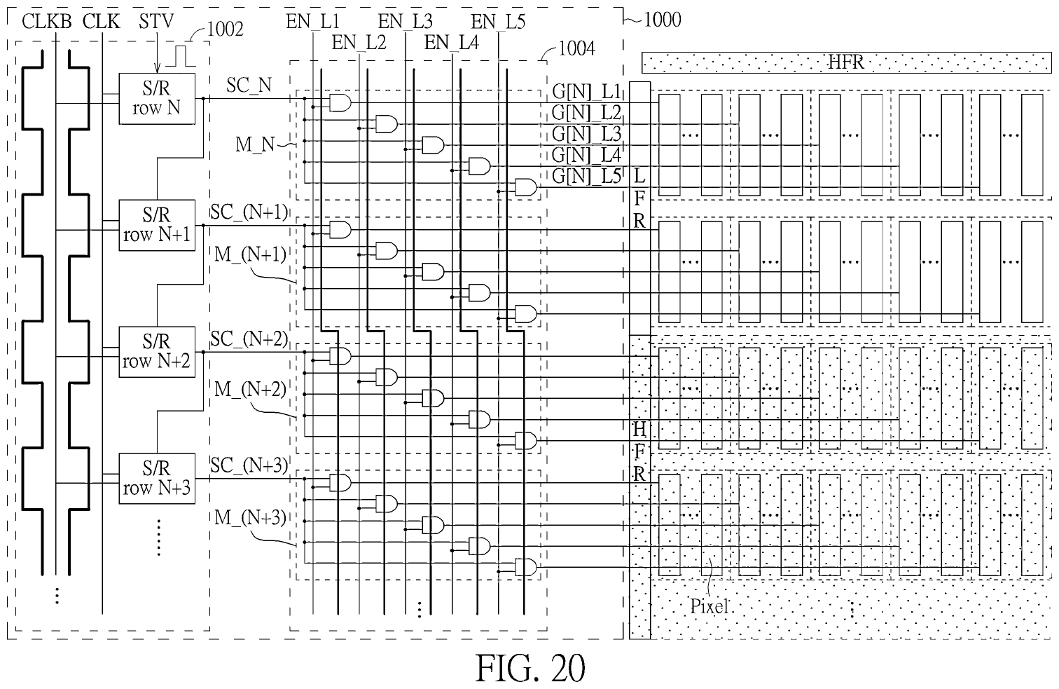

In this embodiment, the frame rate allocation may be realized by using the y-direction partition only, and FIG. 20 illustrates the operations of the scan control circuit to realize this frame rate allocation. As shown in FIG. 20, the enable signals EN_L1-EN_L5 change states at the same time. Therefore, a row of pixels may be entirely in the HFR area or entirely in the LFR area. As shown in FIG. 19, the pixel rows between row R and row M are in the HFR area, and other pixel rows are in the LFR area.

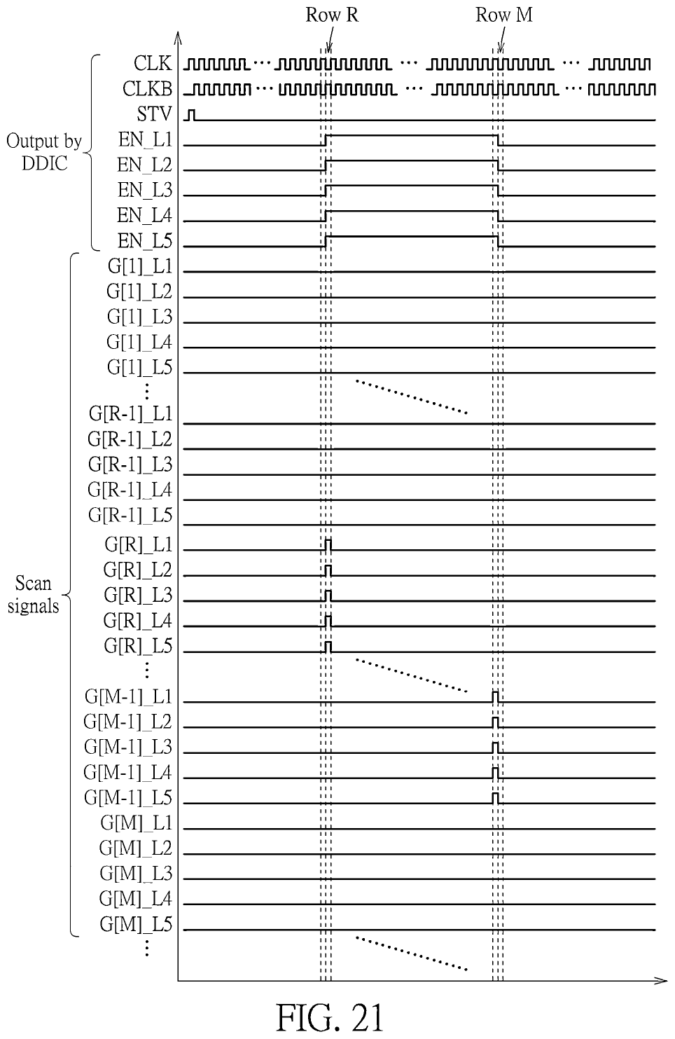

The detailed waveforms of the scan control circuit in this embodiment are illustrated in FIG. 21, where the scan signals on the display panel 700 and the signals output by the DDIC 720 are shown. As shown in FIG. 21, all the enable signals EN_L1-EN_L5 are switched to “High” at row R and switched to “Low” at row M. Therefore, the scan signals are sequentially output in all the scan lines between row R and row M−1 (R<(M−1)).

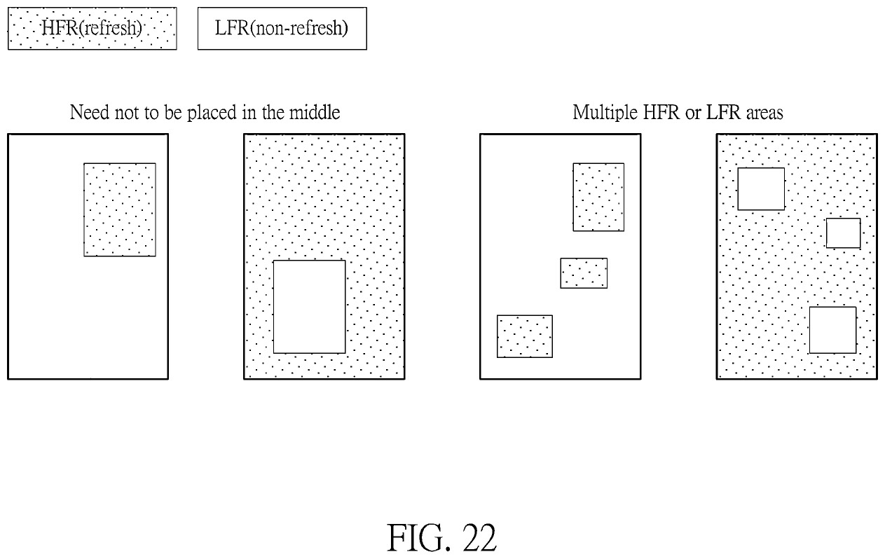

As can be seen, based on the implementation of grouping each row of pixels and the structure of the scan control circuit provided in the present invention, the refresh areas and non-refresh areas may be allocated in any appropriate manner by performing x-direction partition, y-direction partition, or both, where a group of pixels (rather than an entire row of pixels) may be taken as a unit for frame rate allocations. FIG. 22 illustrates several possible HFR and LFR allocations on a display panel. Note that the allocation of frame rates does not need to be symmetric. For example, an HFR area or an LFR area needs not to be placed in the middle rows or middle columns. Instead, it may be deployed in any manner based on the image content. In other embodiments, there may be multiple HFR blocks and/or multiple LFR blocks in an image frame. Each group of pixels may be flexibly and dynamically allocated to the HFR area to receive a set of scan signals for refreshing or allocated to the LFR area to stop the refresh operations, as may be controlled by multiple enable signals output from the DDIC. In fact, the frame rate allocation method is not limited to those described in this disclosure.

The implementation of omitting the refresh of partial pixels on the display panel aims at saving power consumption. If the display panel shows a static image in most areas, these areas may be operated in an extremely low frame rate and refreshed in few image frames. In the non-refresh areas, in addition to stopping outputting the scan signals, power consumption may further be saved by stopping forwarding display data through the data lines. In other words, the DDIC will not output display data to the data lines; hence, the data lines will not be charged or discharged, thereby saving power consumption.

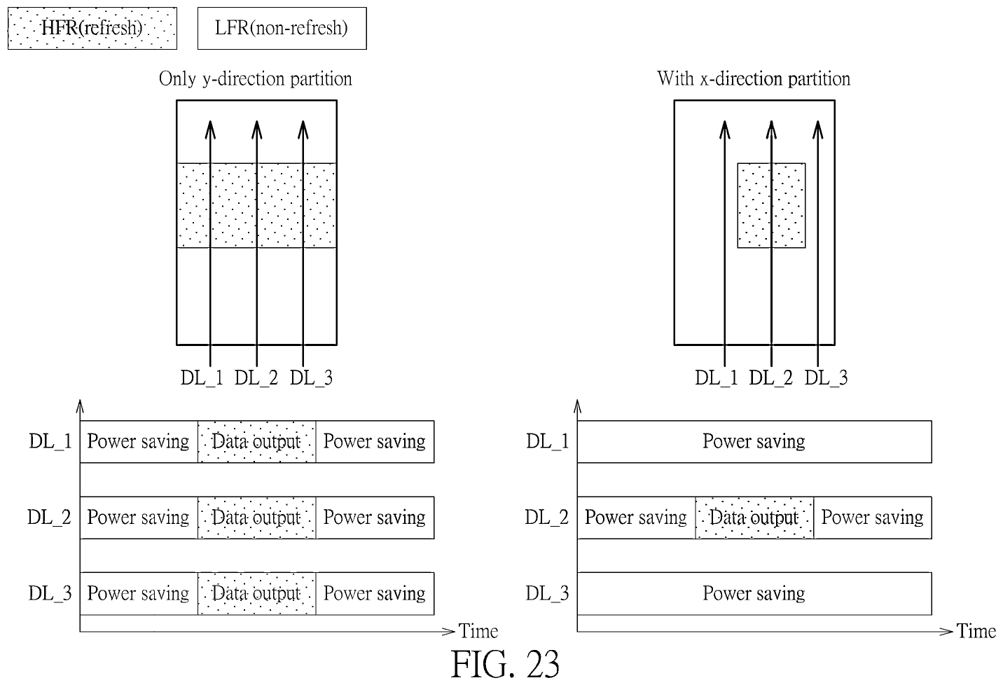

If the x-direction partition is applied along with the y-direction partition, it is possible to minimize the HFR area that needs to be refreshed. Therefore, the power saving effect achieved on the data lines may be optimized, as shown in FIG. 23.

More specifically, if only the y-direction partition is performed (as the left-half part of FIG. 23), the HFR area should include an entire row of pixels, where the data lines DL_1-DL_3 are requested to perform data output. In comparison, when the x-direction partition is incorporated (as the right-half part of FIG. 23), the HFR area is arranged with a group of pixels as a unit. In such a situation, the HFR area may include only the pixels that need to be refreshed; hence, only the data line DL_2 corresponding to the HFR area is requested to perform data output, while the other data lines DL_1 and DL_3 may be disabled (e.g., floating or tied to a specific level), so as to reduce the charging and discharging operations on the data lines.

Note that the DDIC may output display data to the data lines through a source driver, which may include multiple output channels to be coupled to multiple data lines on the display panel, where each output channel may include a source operational amplifier (SOP), a digital-to-analog converter (DAC), a latch circuit, and a shift register. In an embodiment, in order to save power consumption, when a data line does not need to receive image data, the SOP, DAC and/or any other circuit elements in the corresponding output channel may be disabled or turned off. For example, as shown in the right-half part of FIG. 23, the output channels corresponding to the data lines DL_1 and DL_3 may be always off in this frame period. The output channels corresponding to the data line DL_2 may first be off, then turned on when the scan operation proceeds to the HFR area, and then turned off when the scan operation proceeds to the LFR area. Therefore, when the x-direction partition is incorporated, the HFR area may be minimized, and the power saving effects achieved by stopping image data output may be optimized, as compared to another case where only y-direction partition is performed.

In an embodiment, the output channels for different pixel groups may be enabled or disabled by using different enable signals; hence, the circuit elements (such as the SOPs and DACs) in different output channels of the source driver may be controlled differently, so as to achieve power saving based on the frame rate allocation of the display panel.

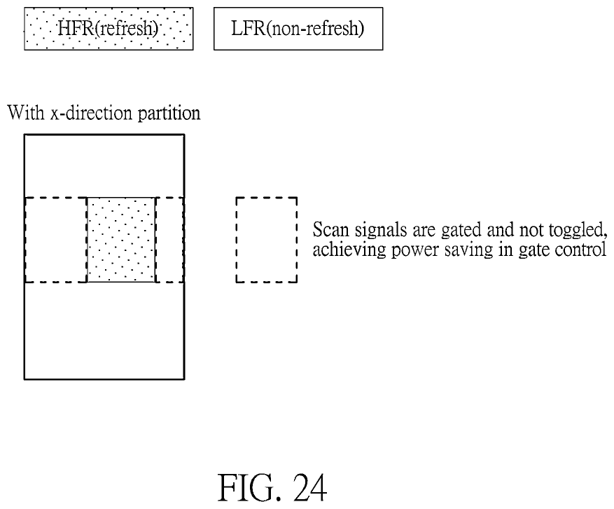

The above paragraphs describe that the DDIC disables the data output and turns off the internal circuit blocks to achieve power saving. In addition, power saving may also be achieved in the gate driver or GOA circuit. As shown in FIG. 24, in the dashed areas (i.e., LFR areas), the scan signals are gated and not toggled; hence, the scan control circuit does not need to drive the loading of the scan lines on the display panel, thereby achieving power saving.

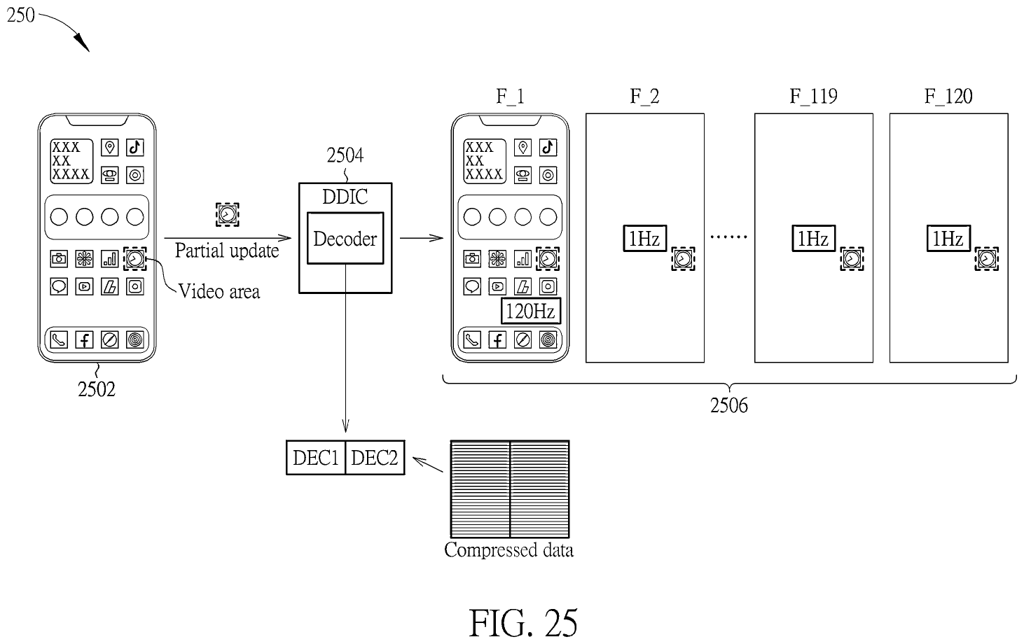

FIG. 25 illustrates an application scenario of the x-direction partition on a display panel of a display system 250. The display system 250, which may be a mobile phone, includes an AP 2502, a DDIC 2504 and a display panel 2506. The display panel 2506 may show a wallpaper, where most images are static while only an app icon shows a dynamically running clock. In such a situation, the clock icon is requested to be displayed with a high refresh rate, while other images are preferably displayed with a low refresh rate for power saving.

In this application, in order to reduce data quantities and save data transmission time between the AP 2502 and the DDIC 2504, the image data sent to the DDIC 2504 from the AP 2502 may be compressed data. For example, a frame of image data may be divided into several compression blocks, and the image data in each block are compressed and packed in the AP 2502 before being output to the DDIC 2504. The DDIC 2504 is usually equipped with 2 decoders DEC1 and DEC2 used for decompressing the received image data, where the decoder DEC1 is responsible for processing the image data of the left-half panel, and the other decoder DEC2 is responsible for processing the image data of the right-half panel. A specific number of rows of pixels at the left-half panel may be divided into a compression block, in which the image data are compressed and sent; and the same rows of pixels at the right half panel may be divided into another compression block, in which the image data are compressed and sent.

In the image frame, the only dynamic part is the icon having the running clock, and the size of this icon may be far smaller than the size of a compression block. Under the transmission scheme with compression, the AP 2502 may compress the image data in a block and output the compressed image data to the DDIC 2504, and then the DDIC 2504 decompresses the received data to restore the original image data. When the partial update implementation is applied, the AP 2502 should send the compressed data of at least one entire block, to ensure that the image data could be decompressed successfully by the decoder (DEC1 and/or DEC2) of the DDIC 2504. In other words, the partial update may be performed by taking a compression block as a transmission unit.

In order to gain the benefit of power saving when there is only a small icon in the image needing to be updated, the AP 2502 may send the raw data of the icon without compression in the partial update mode. In such a situation, the AP 2502 does not need to output all the image data in an entire compression block, which is usually larger than the area of the icon; instead, the AP 2502 only needs to output the image data of the icon. In an embodiment, the AP 2502 may send the address information of the icon along with the raw data of the icon area to the DDIC 2504. Therefore, based on the address information, the DDIC 2504 may refresh the icon area on the display panel 2506 by using the received raw data without decompression. The refresh area may be minimized with the cooperation of the x-direction partition and y-direction partition, and thus it is feasible that the refresh area is far smaller than a compression block. In an embodiment, the AP 2502 and the DDIC 2504 may be configured with a raw data mode where data compression and decompression are omitted. The AP 2502 and the DDIC 2504 may be in a general compression mode to transmit and receive compressed image data if the image frame is fully updated or if the refresh area of partial update is larger than a specific threshold, and they will enter the raw data mode to transmit and receive raw data without compression if the refresh area of partial update is smaller than the threshold.

In an embodiment, in order to achieve the optimal power saving effects of the x-direction partition with partial update in the interface between the AP and the DDIC, the compression scheme may correspond to the x-direction partition and grouping; that is, the image data to be sent to the DDIC may be compressed by taking a group size corresponding to one or more groups of pixels as a unit, and the DDIC may decompress the image data with the same unit.

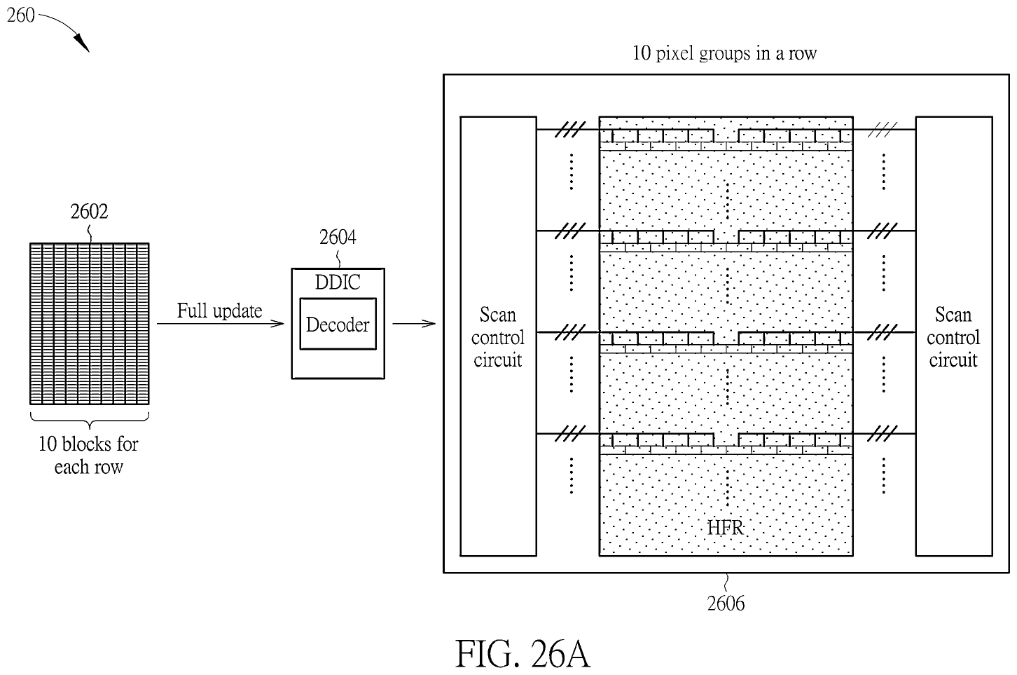

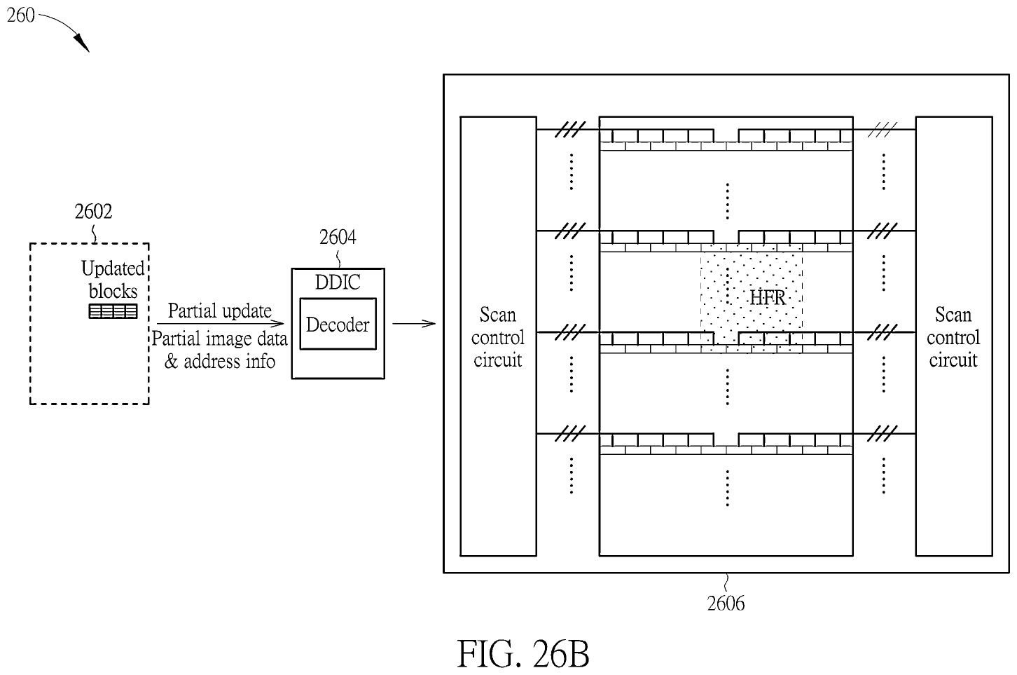

FIG. 26A illustrates a related embodiment, where a display system 260 having an AP 2602, a DDIC 2604 and a display panel 2606 is shown. As shown in FIG. 26A, each row of pixels on the display panel 2606 are divided into 10 groups, and each group is allocated with a frame rate. In this embodiment, a row may include 1080 pixels, and thus each group includes 108 pixels. Correspondingly, the encoder of the AP 2602 may compress the image data based on compression blocks, where each row of pixels may also be divided into 10 compression blocks, where each compression block corresponds to the group size of the x-direction partition (e.g., the column number of a group). Therefore, since there are 1080 pixels in a row, each compression block may include 108 columns of pixels with one or several rows. The DDIC 2604 may include one or more decoders, which performs block-based decompression in a corresponding manner. Therefore, the image data in each block after decompression may correspond to one or several groups.

As shown in FIG. 26A, full update may be performed to refresh all the pixels on the display panel 2606 in an image frame. Therefore, the AP 2602 may send an entire frame of image data to the DDIC 2604. All of the pixels on the display panel 2606 are allocated to the HFR area, and thus may be refreshed in this image frame.

When the partial update along with the MFD operation is performed as shown in FIG. 26B, data compression and decompression are still feasible if they are performed by taking one or more groups of pixels as a unit. In detail, the HFR area where refresh is performed may be allocated to several rows of pixels and 4 pixel groups in each row. The AP 2602 may compress image data in several compression blocks corresponding to the HFR area (i.e., 4 blocks in a row), and send the compressed image data in these blocks to the DDIC 2604. The DDIC 2604 may correspondingly receive the image data in the HFR area and related address information from the AP 2602, in order to decompress the received image data based on the address information. The DDIC 2604 then refreshes the HFR area on the display panel 2606 with these image data.

Note that the present invention aims at providing a method of controlling a display panel under the MFD operation. Those skilled in the art may make modifications and alterations accordingly. For example, in the above embodiments, the MUX circuit controls the scan signal output by using “AND” gates with enable signals to generate high-active pulses on the scan signals. In another embodiment, the logic operation circuits of the MUX circuit may include “OR” gates for generating and outputting low-active scan signals. The high-active scan signals are preferably applied to control the NMOS transistors included in the pixels, and the low-active scan signals are preferably applied to control the PMOS transistors included in the pixels. In addition, the pixels may be grouped in any manner, which should not be limited to those illustrated in the above descriptions. For example, a line of pixels may be divided into any number of groups, where the implementation of 10 pixel groups in a row is only an exemplary embodiment. As long as a line of pixels are divided into multiple groups and each group receives scan signal(s) independently and respectively to realize the x-direction partition, the related implementations should belong to the scope of the present invention.

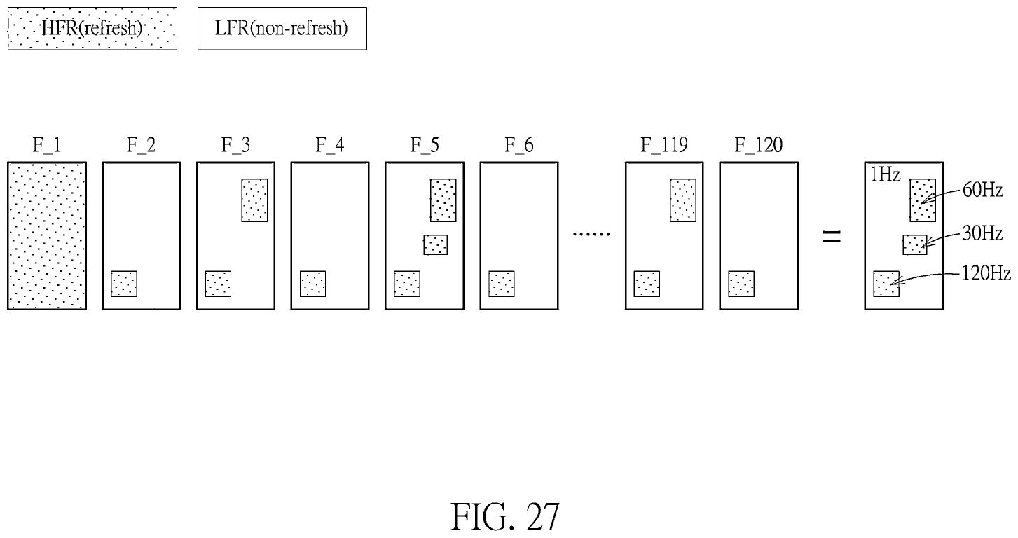

In addition, the frame rate allocation may be used to correspondingly generate one or more HFR areas and one or more LFR areas in an image frame. The combination of a series of image frames having predetermined HFR area(s) and LFR area(s) may realize any combinations of frame rates. For example, FIG. 27 illustrates an exemplary frame rate allocation in a series of image frames F_1-F_120 according to an embodiment of the present invention. Each pixel group in a row may be dynamically allocated to the HFR area or the LFR area, where the pixels are refreshed in the HFR area and not refreshed in the LFR area, so as to realize different frame rates. In this embodiment, most areas display with an extremely low frame rate 1 Hz, and thus are refreshed in 1 of 120 image frames (i.e., refreshed in F_1 only). There is a 60 Hz block which is refreshed in 1 of every 2 image frames, a 30 Hz block which is refreshed in 1 of every 4 image frames, and a 120 Hz block which is refreshed in every one of the 120 image frames F_1-F_120.

To sum up, the present invention provides a novel MFD operation where the allocation of frame rate may be partitioned in x-direction in addition to y-direction. The x-direction is the direction of scan lines connecting a row of pixels. In order to realize the x-direction partition, each row of pixels are divided into multiple pixel groups, and each pixel group is coupled to the respective set of scan line(s). A scan control circuit is deployed on the display panel, to generate multiple scan signals for a row of pixels by receiving multiple enable signals, where the scan signals are determined to be output to the corresponding pixel group based on whether this pixel group needs to be refreshed in each frame. By using different enable signals, each pixel group may be controlled respectively and independently, so as to realize the x-direction partition. The DDIC may output the enable signals to determine the area(s) on the panel that need to be refreshed, and correspondingly enable or disable the source data output to achieve power saving. For example, one or more circuit elements in the source driver may be turned off when they correspond to non-refresh areas and do not need to output image data. In addition, the DDIC may perform partial update to receive image data in a small video area, and thus several signal processing circuits may only require a little processing time and may be disabled to save power at the time when no image data need to be processed. As a result, power saving under the MFD operation may be optimized with the x-direction partition.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of controlling a display panel, the display panel having a plurality of pixels, among which a line of pixels are divided into a plurality of groups of pixels, the method comprising:
generating a scan control signal for the line of pixels when scanning the line of pixels;
outputting a plurality of enable signals, each for controlling one of the plurality of groups of pixels; and
determining whether to output a scan signal to each of the plurality of groups of pixels according to the scan control signal and each of the plurality of enable signals when scanning the line of pixels.

2. The method of claim 1, wherein the plurality of pixels are scanned sequentially along a first direction, and the line of pixels are deployed along a second direction different from the first direction.

3. The method of claim 1, wherein the plurality of groups of pixels comprise a first group of pixels and a second group of pixels, and the method further comprises:
outputting the scan signal to the first group of pixels when scanning the line of pixels in an image frame; and
stopping outputting the scan signal to the second group of pixels when scanning the line of pixels in the image frame.

4. The method of claim 3, wherein the first group of pixels are allocated to a high frame rate (HFR) area, and the second group of pixels are allocated to a low frame rate (LFR) area, wherein a frame rate of the HFR area is greater than a frame rate of the LFR area.

5. The method of claim 3, wherein the first group of pixels are refreshed and the second group of pixels are not refreshed in the image frame.

6. The method of claim 1, wherein the step of determining whether to output the scan signal to each of the plurality of groups of pixels comprises:
performing a logic operation on the scan control signal and each of the plurality of enable signals, to determine whether to output the scan signal to each of the plurality of groups of pixels.

7. The method of claim 1, wherein the plurality of groups of pixels comprise a first group of pixels and a second group of pixels, and the first group of pixels are controlled by a first set of scan signals, and the second group of pixels are controlled by a second set of scan signals different from the first set of scan signals.

8. The method of claim 7, wherein each set of the first set of scan signals and the second set of scan signals comprises a first scan signal generated from a first scan control signal and a second scan signal generated from a second scan control signal.

9. The method of claim 8, wherein the first scan signal is generated according to a first enable signal among the plurality of enable signals, and the second scan signal is generated according to a second enable signal among the plurality of enable signals different from the first enable signal.

10. The method of claim 1, wherein image data of the plurality of pixels are compressed or decompressed by taking a group size corresponding to one or more of the plurality of groups of pixels as a unit.

11. The method of claim 1, wherein an image frame has a refresh area, and the method further comprises:
receiving raw data of the image frame without compression when the refresh area is smaller than a threshold; or
receiving compressed image data of the image frame when the refresh area is greater than the threshold.

12. A display driver circuit for controlling a display panel, the display panel having a plurality of pixels, among which a line of pixels are divided into a plurality of groups of pixels, the display driver circuit being to:
control a scan control circuit to generate a scan control signal for the line of pixels when the line of pixels are scanned;
output a plurality of enable signals, each for controlling one of the plurality of groups of pixels; and
determine whether to output a scan signal to each of the plurality of groups of pixels according to the scan control signal and each of the plurality of enable signals when the line of pixels are scanned.

13. The display driver circuit of claim 12, wherein the plurality of pixels are scanned sequentially along a first direction, and the line of pixels are deployed along a second direction different from the first direction.

14. The display driver circuit of claim 12, wherein the plurality of groups of pixels comprise a first group of pixels and a second group of pixels, and the display driver circuit is further to:
output the scan signal to the first group of pixels when the line of pixels are scanned in an image frame; and
stop outputting the scan signal to the second group of pixels when the line of pixels are scanned in the image frame.

15. The display driver circuit of claim 14, wherein the first group of pixels are allocated to a high frame rate (HFR) area, and the second group of pixels are allocated to a low frame rate (LFR) area, wherein a frame rate of the HFR area is greater than a frame rate of the LFR area.

16. The display driver circuit of claim 14, wherein the first group of pixels are refreshed and the second group of pixels are not refreshed in the image frame.

17. The display driver circuit of claim 12, further to control the scan control circuit to perform a logic operation on the scan control signal and each of the plurality of enable signals, to determine whether to output the scan signal to each of the plurality of groups of pixels.

18. The display driver circuit of claim 12, wherein the plurality of groups of pixels comprise a first group of pixels and a second group of pixels, and the first group of pixels are controlled by a first set of scan signals, and the second group of pixels are controlled by a second set of scan signals different from the first set of scan signals.

19. The display driver circuit of claim 18, wherein each set of the first set of scan signals and the second set of scan signals comprises a first scan signal generated from a first scan control signal and a second scan signal generated from a second scan control signal.

20. The display driver circuit of claim 19, wherein the first scan signal is generated according to a first enable signal among the plurality of enable signals, and the second scan signal is generated according to a second enable signal among the plurality of enable signals different from the first enable signal.

21. The display driver circuit of claim 12, further comprising:
a decoder to decompress image data of the plurality of pixels by taking a group size corresponding to one or more of the plurality of groups of pixels as a unit.

22. The display driver circuit of claim 12, wherein an image frame has a refresh area, and the display driver circuit is further to:
receive raw data of the image frame without compression when the refresh area is smaller than a threshold; or
receive compressed image data of the image frame when the refresh area is greater than the threshold.

23. A scan control circuit of a display panel, the display panel having a plurality of pixels, the scan control circuit comprising:
at least one shift circuit, each to generate a plurality of scan control signals, each of the plurality of scan control signals for a line of pixels among the plurality of pixels; and
a multiplexer circuit, coupled to the at least one shift circuit, to receive the plurality of scan control signals and a plurality of enable signals, to generate and output a plurality of scan signals to the plurality of pixels;
wherein a line of pixels among the plurality of pixels are divided into a plurality of groups of pixels, and each of the plurality of scan signals for the line of pixels corresponds to one group of the plurality of groups of pixels.

24. The scan control circuit of claim 23, wherein the multiplexer circuit comprises a plurality of logic operation circuits, among which a first logic operation circuit is coupled to the line of pixels.

25. The scan control circuit of claim 24, wherein the first logic operation circuit comprises a plurality of output terminals, each coupled to a group of pixels among the plurality of groups of pixels.

26. The scan control circuit of claim 24, wherein the first logic operation circuit receives a first scan control signal among the plurality of scan control signals from the at least one shift circuit and receives the plurality of enable signals, to generate a plurality of first scan signals among the plurality of scan signals and output the plurality of first scan signals to the line of pixels.

27. The scan control circuit of claim 26, wherein each of the plurality of first scan signals is output to a group of pixels among the plurality of groups of pixels.

28. The scan control circuit of claim 26, wherein the first logic operation circuit comprises a plurality of logic gates, each performing a logic operation on the first scan control signal and one of the plurality of enable signals, to generate one of the plurality of first scan signals.

29. The scan control circuit of claim 28, wherein each of the plurality of scan signals is a high-active signal, and each of the plurality of logic gates is an “AND” gate.

30. The scan control circuit of claim 23, wherein each of the at least one shift circuit comprises a plurality of shift registers, each for outputting one of the plurality of scan control signals for controlling a line of pixels among the plurality of pixels.

31. The scan control circuit of claim 23, wherein the plurality of groups of pixels comprise a first group of pixels and a second group of pixels, and the first group of pixels are controlled by a first set of scan signals, and the second group of pixels are controlled by a second set of scan signals different from the first set of scan signals.

32. The scan control circuit of claim 31, wherein each set of the first set of scan signals and the second set of scan signals comprises a first scan signal corresponding to a first shift circuit among the at least one shift circuit and a second scan signal corresponding to a second shift circuit among the at least one shift circuit.
